(19) United States
(12) Patent Application Publication
(10) Pub. No.: US 2025/0262814 A1
(43) Pub. Date: Aug. 21, 2025

(54) 3D PRINTING SYSTEM AND METHOD

(71) Applicant: Pengkai JI, Shanghai (CN)

(72) Inventor: Pengkai JI, Shanghai (CN)

(21) Appl. No.: 19/066,294

(22) Filed: Feb. 28, 2025

Related U.S. Application Data
(63) Continuation of application No. PCT/CN2023/114767, filed on Aug. 24, 2023.

(30) Foreign Application Priority Data
Aug. 29, 2022 (CN) 202211063122.6

(51) Int. Cl. B29C 64/112; B29C 35/16; B29C 64/118; B29C 64/209; B29C 64/236; B29C 64/241; B29C 64/321; B33Y 30/00; B33Y 40/00

(52) U.S. Cl. CPC B29C 64/112; B29C 64/118; B29C 64/209; B29C 64/236; B29C 64/241; B29C 64/321; B33Y 30/00; B29C 2035/1616; B29C 2035/1658; B33Y 40/00

(57) ABSTRACT

A 3D printing system includes a printing head, a base frame and a material platform. The printing head includes a printing seat and a nozzle seat, where the nozzle seat may rotate relative to the printing seat, and an extrusion opening is formed in the nozzle seat. The material platform includes a frame which may rotate relative to the base frame, and at least one feeding component. The feeding component includes a rotatable follow-up portion arranged on the frame, and the feeding component is used for conveying printing materials to the extrusion opening. A flexible line is connected between the frame and the nozzle seat, and includes a conveying line formed between the feeding component and the extrusion opening for conveying printing materials. The platform frame may rotate following the nozzle seat to prevent excessive winding of the flexible line.

### CROSS-REFERENCE TO RELATED APPLICATIONS

This application is a continuation of International Patent Application No. PCT/CN2023/114767, filed on Aug. 24, 2023, which claims the benefit of priority from Chinese Patent Application No. 202211063122.6, filed on Aug. 29, 2022. The content of the aforementioned application, including any intervening amendments thereto, is incorporated herein by reference in its entirety.

### TECHNICAL FIELD

The invention belongs to the technical field of 3D printing, and relates to a 3D printing system with a rotatable material platform and a printing method.

### BACKGROUND

The 3D printing is based on a digital model file, and an object is constructed in a layer-by-layer printing manner, wherein the melt extrusion molding process, namely FFF (Fused Filament Fabrication) or the FDM mode, is used for extruding a printing material through a nozzle moving along a printing path and stacking the printing materials layer by layer to form a three-dimensional model. According to the layer pattern information of the digital model file, the printing head and the printing bed move relative to each other in the XY plane, so that the printing head can reach any position in a certain area above the printing bed, the printing head extrudes the printing material at an appropriate speed while moving above the printing bed until one layer of printing is completed, after one layer of printing is completed, the printing head and the printing bed are separated from each other by a certain distance, such as the layer thickness, then a new layer is continuously printed, and the printing head and the printing bed are stacked layer by layer until a three-dimensional entity is formed. The printing material is usually a kind of meltable thermoplastic material, building slurry, food slurry or biological slurry and the like, and building mud or biological medicine slurry may not be heated.

In a traditional melt extrusion type 3D printing mode, printing material is extruded to form a preset model through a nozzle following a preset path, the nozzle generally adopts a circular shape, so that the extrusion effect of the nozzle in different moving directions is the same, but when a non-circular nozzle may be difficult to apply, or other devices are arranged in front of or behind the moving direction of the nozzle, it is difficult to guarantee that the device is located in front of or behind the nozzle when the nozzle changes the moving direction, for example, the other nozzle must always maintains in front of or behind the nozzle.

In addition, in an existing 3D printing device, it is difficult to realize simultaneous printing with a plurality of nozzles. A 3D printer having a plurality of nozzles, such as two nozzles, generally alternately performs extrusion printing. Although multiple nozzles can print at the same time through the rotation of multiple nozzles of the printing head, the rotation of multiple nozzles or rotation of a single nozzle is often restrained by the twisting effect of wire feeding pipes or wire harness. The control process of the multi-nozzle is additionally limited by the physical structure of the printer, so that the flexibility, the printing speed, the printing precision and the like of the printing process are influenced, and the development difficulty of the control system is increased.

### SUMMARY

The invention aims to solve the technical problem of providing a 3D printing system and method with high flexibility, high printing precision, printing speed and/or dynamic performance in order to overcome at least one of defects in the prior art. Further, the 3D printing system and method may accommodate printing with non-circular nozzles (extrusion opening) and simultaneous extrusion printing of multiple nozzles.

According to the technical scheme, the technical problem is solved:

The invention provides a 3D printing system. The 3D printing system comprises:
a printing head;
a base frame;
a material platform;
a first driving mechanism; and
a second driving mechanism;
wherein the printing head comprises a printing seat and a nozzle seat; the nozzle seat is arranged on the printing seat; the nozzle seat is configured to rotate around a first axis relative to the printing seat; a side of the nozzle seat along the first axis is provided with an extrusion opening for extruding a printing material;
the material platform comprises a platform frame and at least one feeding component; the platform frame is arranged on the base frame; the platform frame is configured to rotate around a second axis relative to the base frame; the at least one feeding component comprises a rotary follow-up portion arranged on the platform frame; the rotary follow-up portion is configured to rotate with the platform frame;
the first driving mechanism is configured for driving the platform frame to rotate following the rotation of the nozzle seat, and the second driving mechanism is configured for driving the nozzle seat to rotate; and
a flexible line is connected between the platform frame and the nozzle seat, and the flexible line comprises a conveying line; the conveying line is provided between the at least one feeding component and the extrusion opening for conveying the printing material;
the first driving mechanism may drive the platform frame following the rotation of the nozzle seat for preventing or reducing excessive winding of the flexible line (even possible to achieve almost non-winding).

According to the technical scheme, the printing head is independently arranged relative to the material platform, there is no rigid connection between the material platform and the printing head, the material platform, and is only connected through a flexible line between the printing head and the material platform, so that a heavy feeding component (such as a material source, a material spool, a funnel or an extruder and the like) and the like are arranged on the material platform instead of the printing head, and the printing head is simple and light in structure, so that the printing head has the characteristics of small mass and low inertia; and the platform frame rotates following the nozzle seat, so that excessive winding of the line between the material platform and the printing head can be avoided (even possibly not wound), extra limitation of the material platform on the rotation of the nozzle seat of the printing head is avoided, the flexibility of the printing process is improved, and the printing precision, the printing speed and the dynamic performance are improved. In addition, by arranging the extrusion opening on the rotatable nozzle seat, the nozzle seat may rotated to adapt to printing with a non-circular nozzle (an extrusion opening) and simultaneous extrusion printing of a plurality of nozzles, or a electric device or an roller on the printing head rotates around the extrusion opening. In the technical solution, the printing head may plan a printing path of a nozzle (or an extrusion opening) or a multi-nozzle (ie, a multi-extrusion opening) freely or more optimized.

### BRIEF DESCRIPTION OF THE DRAWINGS

FIG. 1 is a schematic diagram of a 3D printing system provided with a material spool arranged on a material platform and an extrusion opening arranged on a printing head according to the present invention;

FIG. 2 is a schematic diagram of a 3D printing system provided with a conductive slip ring and a rotation sensing device on a material platform, and the nozzle seat is provided with two extrusion openings and a cooling fan, a detector and an ink jet head;

FIG. 3 is a schematic diagram of a 3D printing system provided with a closed material bin on the material platform, far-end air supply on the material platform, a driving mechanism for driving the material platform to rotate and a continuous fiber printing cutter;

FIG. 4 is a schematic diagram of a 3D printing system with a center shaft structure, a conductive slip ring with a via hole external air supply, an roller arranged on a nozzle seat and an inclined nozzle portion arranged on a second nozzle seat portion. According to the 3D printing system,

FIG. 5 is a schematic diagram of a 3D printing system of a conductive slip ring combining two extrusion openings into one extrusion opening and an electromagnetic induction mode conductive slip ring according to the invention;

FIG. 6 is a schematic diagram of a 3D printing system which is provided with a material spool arranged on material platform, and a printing head with an extrusion opening which is inclined backwards, and other auxiliary devices are arranged at the front and back of the nozzle respectively;

FIG. 7 is a schematic diagram of a 3D printing system for carrying out multi-continuous fiber printing, a plurality of feeders and a plurality of spools on a material platform and driving a nozzle seat to rotate by the moving speed difference of the two synchronous belts according to the multi-opening extrusion unit;

FIG. 8 is a schematic diagram of a 3D printing system arranged on a material platform by adopting a flowable printing material printing and pumping device according to the invention;

FIG. 9 is a schematic diagram of a 3D printing system for connecting a funnel with a particle material on a material platform to a pumping device fixed on a nozzle seat through a feeding pipe according to the invention;

FIG. 10 is a schematic diagram of a printing system, a roller structure is arranged on the nozzle seat ring, the blast pipe (air pipe) passes through the through hole, and heat dissipation are conducted in the roller;

FIG. 11 is a schematic diagram of a 3D printing system of a material platform provided by the invention by adopting a central shaft structure and adopting a cooling liquid circulating heat dissipation and circulating device to be arranged on the material platform;

FIG. 12 is a schematic diagram of the movement process of an ink jet head and a detector along a printing path according to the printing head of the invention;

FIG. 13 is a schematic diagram of a printing process of changing extrusion width along printing path movement of non-circular extrusion opening while moving along the printing path according to the present invention;

FIG. 14 is a schematic diagram of a 3D printing system provided with a swing arm on a nozzle seat and adopting center shaft structure of the invention;

FIG. 15 is a schematic diagram of the moving stroke of the printing seat is greater than or equal to the rotating radius of the extrusion opening on the nozzle seat.

### DETAILED DESCRIPTION OF EMBODIMENTS

In order to more clearly illustrate the embodiments of the present invention or the technical solutions in the prior art, specific embodiments of the present invention are described below with reference to the accompanying drawings. Obviously, the drawings in the following description are merely some embodiments of the present invention, and for a person of ordinary skill in the art, other drawings may be obtained according to these drawings without creative efforts, and other embodiments are obtained.

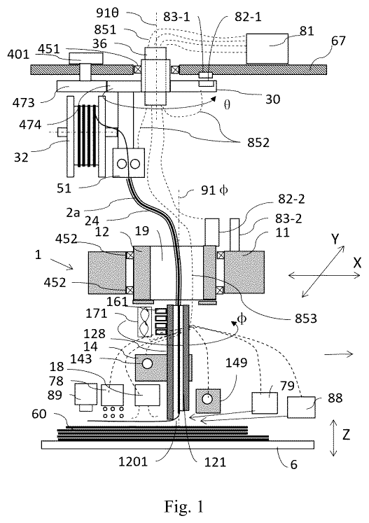

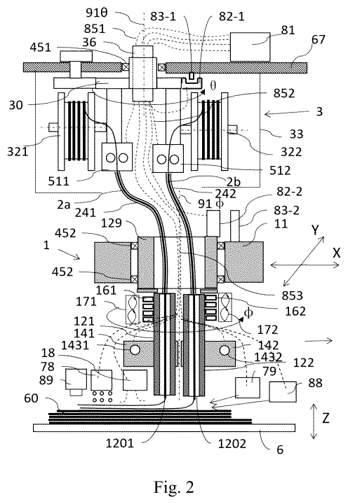

A 3D printing system comprises a printing head 1, a base frame 67 and a material platform (material feeding platform) 3; wherein: the nozzle seat 12 is arranged on the printing seat 11, the nozzle seat 12 may rotate around a first axis (such as the central axis 91Φ of FIG. 1 or FIG. 2) relative to the printing seat, the nozzle seat 12 is provided with an extrusion opening on the side facing the first end of the first axis (usually facing downwards, or other direction), the number of the extrusion openings may be one or more, the extrusion openings are used for extruding printing materials, and the material platform 3 comprises a platform frame (material platform frame) 30 and at least one feeding component, the platform frame (material platform frame) 30 is arranged on the base frame 67, the platform frame 30 may rotate around a second axis (such as the central axis 910 of FIG. 1 or FIG. 2) relative to the base frame 67, the feeding component comprises a rotary follow-up portion arranged on the platform frame 30 (the rotary follow-up portion is a component fixed on the platform frame 30 and may rotate with the platform frame 30), the rotary follow-up portion may rotate with the platform frame 30, and the feeding component is used for conveying or supplying printing materials to the extrusion opening; and a flexible line is connected between the platform frame 30 and the nozzle seat 12. The flexible line comprises a printing material conveying line formed between the feeding component and the extrusion opening and used for conveying a printing material (the printing material conveying path may be a feeding pipe or a continuous filament (wire material) when the printing material is a wire material); and the platform frame 30 may rotate following the rotation of the nozzle seat 12 and is used for preventing or reducing winding of a flexible line, namely, excessive winding of a flexible line is prevented.

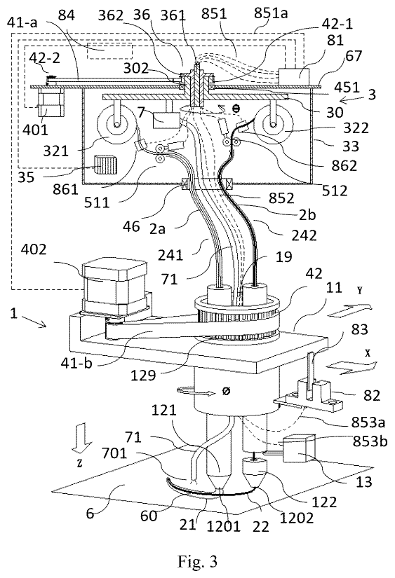

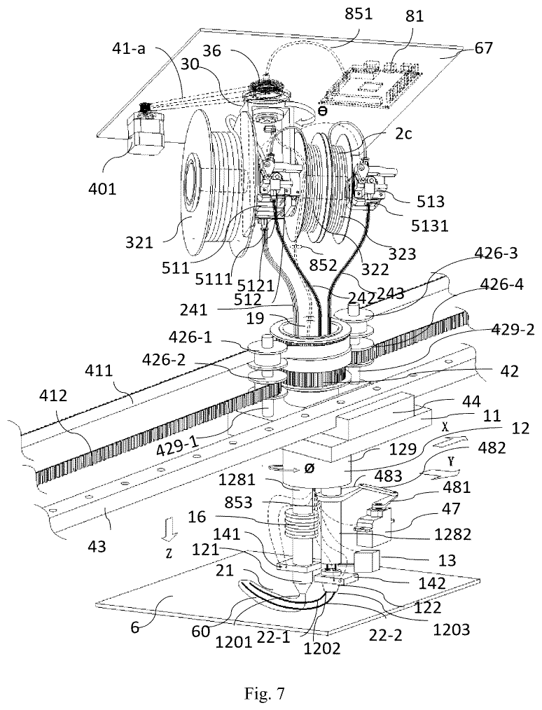

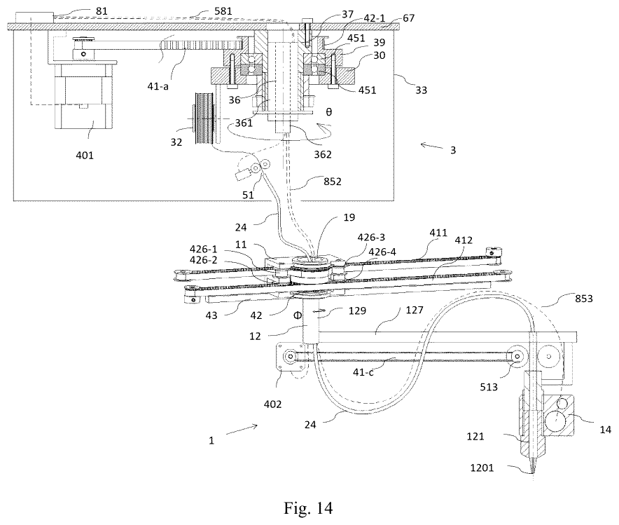

The 3D printing system may comprise two driving mechanisms, a first driving mechanism and a second driving mechanism, wherein the first driving mechanism and the second driving mechanism are respectively used for driving the platform frame and the nozzle seat to rotate; or the 3D printing system further comprises a driving mechanism, the driving mechanism is used for driving the nozzle seat to rotate, and the platform frame is driven by torsion force generated by a flexible line when the nozzle seat rotates. The first rotary driving mechanism of the driving platform frame may drive the material platform to rotate by the second synchronous pulley 42-2, the synchronous belt 41-a and the first synchronous pulley 42-1 as shown in FIG. 3, 6, 7 or 10. As shown in FIG. 7 or FIG. 14, the dual synchronous pulley mechanism may also be used for driving the platform frame 30 to rotate. As shown in FIG. 1 or FIG. 2, the first motor 401 may also drive the platform frame 30 to rotate by the gear 473 and may also be driven by a hollow rotor motor; the second motor 402 which is fixedly connected to the printing seat as shown in FIG. 3 may drive the synchronous pulley 42 to drive the nozzle seat to rotate by the synchronous belt 41-b, the dual synchronous pulley mechanism as shown in FIG. 7 or FIG. 14 may be adopted, the hollow rotor motor may be adopted for driving, and the second motor 402 may also drive the nozzle seat 12 to rotate by the gear 473.

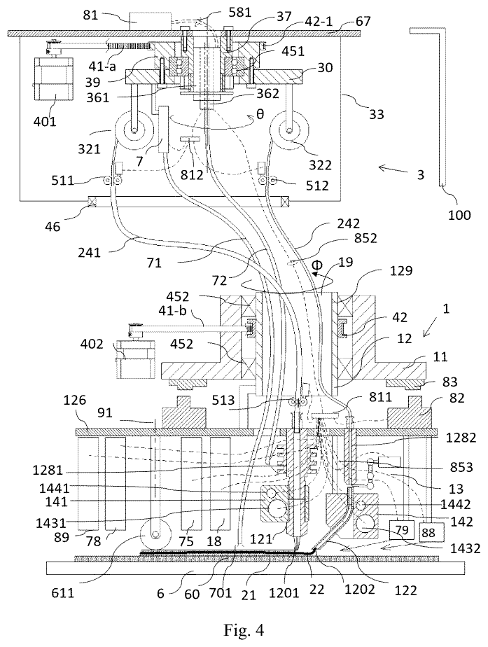

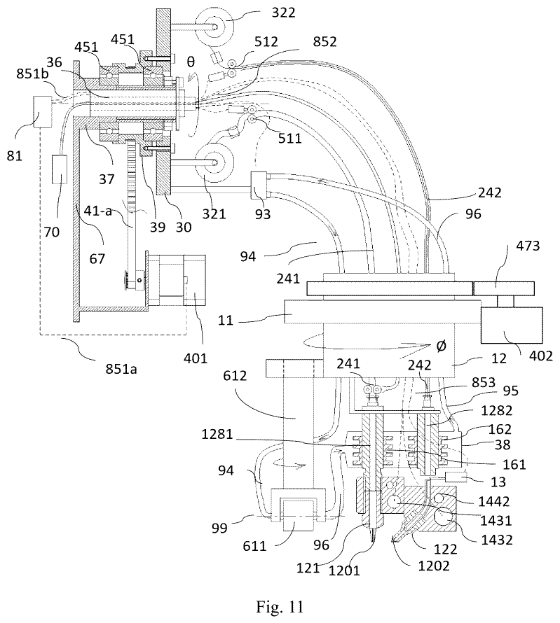

As shown in FIG. 4, FIG. 11 and FIG. 14, the 3D printing system further comprises a center shaft 37 and a bearing 451, the platform frame 30 may rotate relative to the center shaft 37, the bearing 451 comprises an outer ring and an inner ring which may rotate relative to each other, the platform frame 30 is fixedly connected with the outer ring, the center shaft 37 is fixedly connected with the inner ring, and the center shaft 37 is fixedly connected with the base frame 67.

In the printing process, the controller 81 controls the second driving mechanism to drive the nozzle seat 12 to rotate, and the first driving mechanism is controlled to drive the platform frame 30 to rotate following the rotation of the nozzle seat 12, so that the angle difference between the platform frame 30 and the nozzle seat 12 of the printing head is smaller than or equal to a preset value (the preset value of angle difference maybe 0 or greater than 0); and/or the rotation angle range of the platform frame is not greater than (or less than) the rotation angle range of the nozzle seat; and/or the rotational angular velocity of the platform frame is not greater than (or less) the rotational angular velocity of the nozzle seat; and/or the rotational angular acceleration of the platform frame is not greater than (or less) the rotational angular acceleration of the nozzle seat.

The 3D printing system further comprises a first rotation sensing device, wherein the first rotation sensing device comprises a sensor and a sensing component correspondingly arranged, the sensor and the sensing component are respectively connected with the platform frame and the base frame, the sensor is electrically connected with the controller through the conductive sliding ring, or the sensor and the sensing component are respectively connected with the base frame and the platform frame and used for detecting the rotation angle or the initial position of the platform frame relative to the base frame or the rotation direction; and/or the second rotation sensing device comprises a sensor and a sensing component correspondingly arranged, the sensor and the sensing component are respectively connected with the nozzle seat and the printing seat of the printing head, and the sensor is electrically connected with the controller through the conductive sliding ring (conductive slip ring) and is used for detecting the rotation angle or the initial position of the nozzle seat relative to the printing seat or the rotation direction;

In addition, an electric device, such as a photosensitive curing light source, may also be arranged on the nozzle seat of the printing head, the photosensitive curing light source is located behind the extrusion opening along the movement direction of the printing head by the rotation of the nozzle seat relative to the printing seat, and the photosensitive curing light source is used for curing the printing material extruded from the extrusion opening; and/or a pre-heater which rotates relative to the printing seat by the nozzle seat and is used for heating the area in front of the extrusion opening in the movement direction of the printing head so as to heat the area is about to be printed (Extruding the printing material on the area) by the printing head and/or used for heating the printing material just extruded by the extrusion opening; and/or a temperature measurer (temperature measurement instrument) is rotated relative to the printing seat by the nozzle seat, and a temperature measurement area of the temperature measurer is located in front of the extrusion opening in the movement direction of the printing head so as to measure the temperature of the area is about to be printed by the printing head; and/or, a detector acts on the rear of the extrusion opening along the movement direction of the printing head by the rotation of the nozzle seat relative to the printing seat, so that the quality of the printing material extruded by the extrusion opening is detected by the detector; and/or a cooling fan is located behind the extrusion opening in the movement direction of the printing head and is used for blowing the printing material which is just extruded by the extrusion opening; and/or a ink jet head is rotated relative to the printing seat by the nozzle seat, the ink jet head is located behind the extrusion opening in the moving direction of the printing head, and the ink jet head is used for carrying out ink jet according to a preset pattern on the printing material extruded out from the extrusion opening; the 3D printing system further comprises a printing bed, the printing head and the printing bed may move relative to each other, the extrusion opening extrudes the printing material along a preset printing path, and printing is carried out on the printing bed; an ink jet head is further arranged on the nozzle seat, the ink jet head is located behind the extrusion opening by rotation of the nozzle seat relative to the printing seat in the printing process, the ink jet head is located behind the extrusion opening, the projection of the ink jet head and the printing material extruded by the extrusion opening towards the direction of the printing bed is overlapped, and the ink jet head is used for carrying out ink jet on the printing material extruded by the extrusion opening according to a preset pattern; It may also include a ink cartridge for the ink jet head connected through a ink delivery tube, the ink cartridge is used for storing ink; and the ink jet head is used for ink jetting.

An roller may be further arranged on the nozzle seat, the roller may rotate around the axis of the roller and may rotate relative to the nozzle seat around a third axis (such as the rotation axis of the vertical shaft frame 612), the roller is located behind the printing head by rotation of the nozzle seat relative to the printing seat and the roller is used for pressing the printing material extruded out from the extrusion opening; preferably, the third axis intersects with the axis of the roller, or the third axis coincides with the midpoint of the roller in the axis direction of the roller; alternatively, the third axis does not intersect with the axis of the roller, or the third axis does not coincide with the middle point of the roller in the axis direction of the roller; optimal, the axis of the roller is kept perpendicular to the moving direction of the roller by the rotation of the nozzle seat relative to the printing seat and the rotation of the roller around the third axis;

The fluid cooling device may further comprise a fluid cooling device, the fluid cooling device comprises a fluid source and a fluid pipe, the first end of the fluid pipe is connected with the fluid source, the fluid source is arranged on the platform frame and may rotate with the material platform frame; or the fluid cooling device comprises a sliding sealing ring, a fluid pipe and a fluid source arranged outside, the sliding sealing ring comprises a first sliding ring portion and a second sliding ring portion which may rotate around a second axis and keep sealing, the first sliding ring portion is fixedly connected with the material platform frame, the first end of the fluid pipe is connected with an external fluid source, the sliding sealing ring is arranged on the fluid pipe, the fluid pipe may be disconnected at the sliding sealing ring, and the two fractures may be connected with the first fluid interface and the second fluid interface respectively; and the second end of the fluid pipe may rotate with the nozzle seat and is used for conveying cooling fluid to the nozzle seat so as to carry out temperature control on the printing material or on the printing material conveying line and/or used for conveying cooling fluid to the rear of the extrusion opening in the movement direction of the printing head so as to cool the printing material extruded from the extrusion opening; preferably, a radiator (such as heatsink or fin) is provided with a heat dissipation channel with an inlet and an outlet, and the second end of the fluid pipe is communicated with the inlet of the heat dissipation channel; further preferably, a heat dissipation cavity is formed in the roller, and the second end of the fluid pipe communicates with the inlet of the heat dissipation cavity or the second end of the fluid pipe is connected with the radiator through the heat dissipation cavity; and more preferably, the fluid source is a cooling fluid circulation device, and the fluid cooling device further comprises a backflow fluid pipe connected to the cooling fluid circulation device from an outlet of the heat dissipation channel or an outlet of the heat dissipation cavity. The fluid source may comprise a fan, an air source, an air cooling circulating device or a circulating device used for liquid. The fluid pipe comprises a cooling pipe for the air (gas coolant) or liquid coolant (such as water).
The 3D printing system further comprises a controller, a sliding electric connecting device (such as conductive slip ring) and an electric device, the electric device is arranged on the nozzle seat and/or the material platform, the sliding electric connecting device comprises a first conductive sliding ring portion and a second conductive sliding ring portion which may rotate relative to each other, and the first conductive sliding ring portion and the second conductive sliding ring portion are connected with the base frame and the platform frame respectively;
The electric device is electrically connected with the controller through the sliding electric connecting device, or the 3D printing system further comprises a control mainboard, the control mainboard is arranged on the nozzle seat or the material platform, the electric device is electrically connected with the control mainboard, and the control mainboard is electrically connected with the controller through the sliding electric connecting device;

The flexible line includes at least one electrically conductive circuit for electrical connection.

Preferably, the conductive circuit between the controller and the control mainboard comprises a Bus.

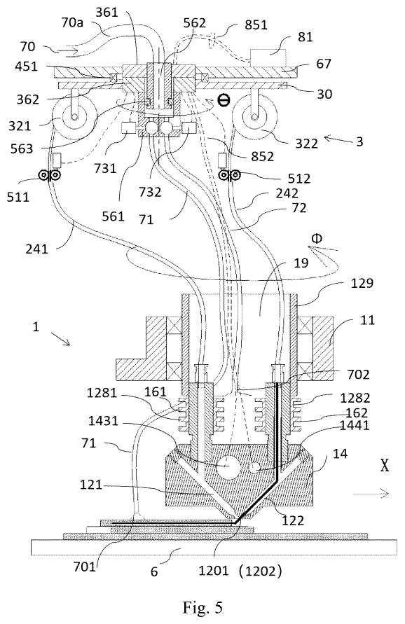

Preferably, the sliding electrical connection device comprises a via hole (a kind of through hole),
The 3D printing system further comprises a fluid cooling device. The fluid cooling device comprises a fluid source (such as an air source 70 or a coolant circulation pumping device in FIG. 11) and a fluid pipeline (such as an blast pipe 70a, 71 or 72, or a liquid cooling pipe of a cooling liquid circulation pipeline). A first end of the fluid pipeline is communicated with the fluid source, the fluid pipe passes through the via hole (as shown in FIG. 4, FIG. 5 or FIG. 11), and a second end of the fluid pipeline may rotate with the nozzle seat or the material platform frame; the second end of the fluid pipeline may be connected to the nozzle seat and is used for blowing fins above the extrusion opening for dissipating heat, or blowing the printing material is just extruded from the nozzle or blowing the extruder (for conveying the printing material to the extruding opening) on the nozzle seat;
The fluid pipeline may be an blast pipe used for conveying gas or a cooling pipe used for conveying liquid coolant.
A sensor, a heating block, a heating core, a heating winding wire, a radiator, a valve, a cutter, a photosensitive curing light source, a pre-heater, a temperature measurer, a detector, an ink jet head, a pre-heater, a cooling fan or a heat dissipation fan may be used as electric components (electric device);
The at least one extrusion unit is a multi-opening extrusion unit, the multi-opening extrusion unit comprises a plurality of extrusion openings, and the multi-opening extrusion unit may rotate relative to the nozzle seat around a fourth axis; preferably, the fourth axis is parallel to the second axis; the multi-opening extrusion unit on the nozzle seat may be provided with three extrusion openings, the two extrusion openings form a multi-opening extrusion unit, the other extrusion opening forms a single-port extrusion unit and is located at the first axis, and the multi-opening extrusion unit and the single-port extrusion unit are arranged at intervals; and further, the multi-opening extrusion unit is obliquely arranged in the direction of the extrusion opening. The extrusion opening rotary driver is arranged on the nozzle seat and may rotate with the nozzle seat, and the extrusion opening rotary driver is in transmission connection with the multi-opening extrusion unit; the extrusion opening rotary driver is provided with a rotary output shaft, and the rotary output shaft is in transmission connection with the multi-opening extrusion unit through a connecting rod mechanism; and further preferably, the connecting rod mechanism may comprise a first connecting rod, a second connecting rod and a third connecting rod which are sequentially pivoted, the tail end of the first connecting rod is connected with the rotary output shaft, and the tail end of the third connecting rod is connected with the multi-opening extrusion unit.

The nozzle seat is provided with at least one extrusion opening, the nozzle seat is further provided with at least one material-pipe-end (or hot end), the material-pipe-end may rotate with the nozzle seat, each extrusion opening is formed at one end of one material-pipe-end, or each extrusion opening is formed at the junction of one end of the at least two material-pipe-ends.

The 3D printing system further comprises two moving driving mechanism, wherein one moving driving mechanism is connected with the base frame to drive the material platform to move, and the other moving driving device is connected with the printing seat to drive the printing head to move; or the 3D printing system further comprises a moving driving mechanism, the moving driving mechanism is connected with a printing seat of the printing head so as to drive the printing head to move, and when the printing head moves, the base frame is driven to move by a flexible line.
The 3D printing system further comprises a guide rail 43, and the printing seat 11 may move along the guide rail 43;
The nozzle seat 12 comprises a nozzle seat ring 129 with the through hole 19, and the printing material conveying line (such as a first feeding pipe 241) passes through the through hole 19;
The nozzle seat further comprises a swing arm 127, the swing arm 127 is arranged on the side, away from the material platform 3, of the printing seat 11 in the direction of the flexible line, the swing arm is connected with the nozzle seat ring 129 and may rotate with the nozzle seat ring 129, and the extrusion opening (such as a extrusion opening 1201) is arranged on the swing arm 127.

Preferably, the stroke of the printing seat moving along the guide rail is greater than or equal to twice the rotation radius of the extrusion opening around the first axis.
The 3D printing system further comprises a printer frame 100 (as shown in FIG. 4), wherein the base frame is fixedly connected to the printer frame 100; or,
The base frame may move relative to the printer frame 100, and when the position difference between the printing head and the material platform is greater than or equal to a preset value, the material platform moves in the corresponding direction following the moving of the nozzle seat;
And/or the movement range of the material platform is not greater than (or less than) the movement range of the printing head;
And/or the moving speed of the material platform is not greater than (or less than) the moving speed of the printing head;
And/or the movement acceleration of the material platform is not greater than (or less than) the movement acceleration of the printing head.
a fan (or blower) is arranged on the platform frame and may rotate with the material platform frame, the fluid pipe is an blast pipe (air pipe), the first end of the blast pipe communicates with the fan, the nozzle seat comprises a nozzle seat ring with a through hole, the blast pipe passes through the nozzle seat ring, and the second end of the blast pipe may rotate with the nozzle seat,
Wherein,
Along the moving direction of the printing head, the second end of the blast pipe is arranged behind the printing head, and the second end of the blast pipe blows air towards a printing material just extruded out of the extrusion opening and is used for dissipating heat of the just-extruded printing material;
Or the second end of the blast pipe (air pipe) blows air towards the radiator (such as heatsink of fin), and the radiator is arranged on the printing material conveying line and used for controlling the temperature of the printing material;
Or, the printing head further comprises a heat dissipation channel and a material-pipe-end, the second end of the blast pipe communicates with the inlet of the heat dissipation channel, a radiator is arranged in the heat dissipation channel, or the heat dissipation channel is a pipeline which is formed on the pipe wall of the material-pipe-end and is not communicated with the printing material conveying line, the material-pipe-end is a pipeline for conveying printing materials of the printing material conveying line on the printing head, or the heat dissipation channel is a pipeline tightly attached to the pipe wall of the material-pipe-end, maybe by the spiral winding;

Alternatively, the printing head further comprises an roller, the second end of the blast pipe is communicated with an inlet of a heat dissipation cavity in the roller, and the roller is connected to the nozzle seat ring and may rotate with the nozzle seat ring.

The first end of the blast pipe is communicated with the air source, the blast pipe maybe disconnected at the sliding sealing ring, the two fractures are connected with a first fluid interface and a second fluid interface of the sliding sealing ring respectively, a valve maybe arranged on the sliding sealing ring or the blast pipe and used for controlling the conveying of air in the blast pipe, the nozzle seat comprises a nozzle seat ring with a through hole, the blast pipe passes through the nozzle seat ring, and the second end of the blast pipe rotates with the nozzle seat,
Wherein,
Along the moving direction of the printing head, the second end of the blast pipe is arranged behind the printing head, and the second end of the blast pipe blows air towards a printing material just extruded out of the extrusion opening and is used for dissipating heat of the printing material just-extruded by the extruding opening;
Or the second end of the blast pipe blows air towards the radiator, and the radiator is arranged on the printing material conveying line and used for controlling the temperature of the printing material;
Alternatively, the printing head further comprises a heat dissipation channel and a material-pipe-end, the second end of the blast pipe is communicated with the inlet of the heat dissipation channel, a radiator is arranged in the heat dissipation channel, or the heat dissipation channel is a pipeline which is formed on the pipe wall of the material-pipe-end and is not communicated with the printing material conveying line, the material-pipe-end is a pipeline for conveying printing materials of the printing material conveying line on the printing head, or the heat dissipation channel is a pipeline tightly attached to the spiral winding of the pipe wall of the material-pipe-end;

Alternatively, the printing head further comprises an roller, the second end of the blast pipe is communicated with an inlet of a heat dissipation cavity in the roller, and the roller is connected to the nozzle seat ring and may rotate with the nozzle seat ring.

Preferably, the fluid source is a circulating device for liquid, the circulating device is arranged on the platform frame and rotates with the material platform frame, the fluid pipe is a cooling pipe for conveying liquid, the cooling pipe comprises a first cooling pipe and a second cooling pipe, the first end of the first cooling pipe communicates with a outlet of the circulating device, the first end of the second cooling pipe communicates with an inlet of the circulating device, the nozzle seat comprises a nozzle seat ring with a through hole, and the first cooling pipe and the second cooling pipe pass through the nozzle seat ring, and the second ends of the first cooling pipe and the second cooling pipe may rotate by the nozzle seat,
Wherein,
a second end of the first cooling pipe communicates with an inlet of a heat dissipation cavity in the roller, and a second end of the second cooling pipe communicates with an outlet of a heat dissipation cavity in the roller;
Or, the second end of the first cooling pipe communicates with the inlet of the heat dissipation channel, and the second end of the second cooling pipe communicates with the outlet of the heat dissipation channel;
Or, the fluid cooling device further comprises a third cooling pipe, the first end of the third cooling pipe communicates with the outlet of the heat dissipation cavity in the roller, and the second end of the third cooling pipe communicates with the inlet of the heat dissipation channel; the second end of the second cooling pipe communicates with the outlet of the heat dissipation channel, or the second end of the second cooling pipe communicates with the inlet of the heat dissipation cavity in the roller, and the second end of the first cooling pipe communicates with the outlet of the heat dissipation channel; the heat dissipation channel is a pipeline which is formed on the pipe wall of the material-pipe-end and is not communicated with the printing material conveying line, or the heat dissipation channel is a pipeline which is tightly attached to the spiral winding of the pipe wall of the material-pipe-end, and the material-pipe-end is a pipeline for conveying printing materials of the printing material conveying line on the nozzle seat.
Preferably, a extrusion opening and a second extrusion opening are arranged on the nozzle seat; a first material spool and a second material spool are arranged on the material platform to serve as rotatory follow-up portions of two corresponding feeding components; The first material spool is wound with a meltable resin filament, the meltable resin filament is conveyed to the extrusion opening through the first feeding pipe and extruded by the extrusion opening to print the melt resin printing material, the second material spool is wound with a continuous fiber filament material, the continuous fiber filament material is conveyed to the second extrusion opening through the second feeding pipe, and the continuous fiber filament material is extruded from the second extrusion opening;
and the second extrusion opening is kept in front of the extrusion opening by rotation of the nozzle seat relative to the printing seat; and/or the second extrusion opening is obliquely arranged, and in the printing process, the second extrusion opening is kept inclined towards the rear in the moving direction of the printing head by rotation of the nozzle seat relative to the printing seat, and/or the second extrusion opening is combined to the first extrusion opening;
Wherein,
Or the printing head continuously performs printing of a continuous fiber filament material and a composite material of the meltable resin filament material along a preset printing path in a spiral shape in the vertical direction, or the printing head continuously performs composite material printing of the continuous fiber filament material and the meltable resin filament material along a preset printing path in a spiral shape in the horizontal direction;
Or, preferably, the nozzle seat further comprises a screw extruder, a flowable meltable resin printing material or a flowable photosensitive resin printing material is arranged in the screw extruder, a first extrusion opening and a second extrusion opening are formed on the nozzle seat, the extrusion unit corresponding to the first extrusion opening adopts the screw extruder, the screw extruder is connected to the nozzle seat and may rotate with the nozzle seat, a second material spool is arranged on the material platform frame, continuous fiber filaments are wound on the second material spool, the continuous fiber filaments are conveyed to the second extrusion opening through the second feeding pipe, and the continuous fiber filaments are extruded from the second extrusion opening.

The feeding component comprises a funnel, the funnel is arranged on the platform frame or connected to the material platform through a sliding sealing ring, the flexible line further comprises a first feeding pipe, the first end of the first feeding pipe communicates with a discharging port of the funnel, and the second end of the first feeding pipe communicates with a feeding port of the screw extruder.

The second extrusion opening is kept in front of the extrusion opening by rotation of the nozzle seat relative to the printing seat; preferably, the second extrusion opening is obliquely arranged, and in the printing process, the second extrusion opening is kept inclined towards the rear in the moving direction of the printing head by rotation of the nozzle seat relative to the printing seat;
Wherein,
Or the printing head continuously carries out composite material printing containing continuous fibers in a spiral preset printing path in the vertical direction, or the printing head continuously comprises composite material printing of continuous fibers in a spiral preset printing path in the horizontal direction; further preferably, the feeding component further comprises a funnel, the funnel is arranged on the platform frame or connected to the material platform through a sliding sealing ring, the flexible line further comprises a first feeding pipe, the first end of the first feeding pipe communicates with a discharging port of the funnel, and the second end of the first feeding pipe communicates with a feeding port of the screw extruder.

More specifically,

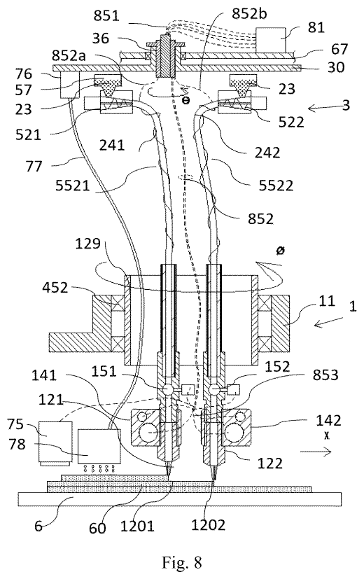

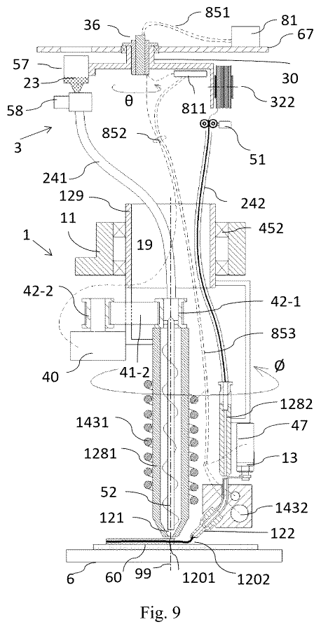

FIG. 2, FIG. 3, FIG. 4, FIG. 7, FIG. 8, FIG. 9, FIG. 11, and FIG. 14 illustrate a multi-nozzle parallel printing system having a plurality of nozzles (ie, a plurality of extrusion openings, such as a first extrusion opening 1201 and a second extrusion opening 1202). A printing seat 11 of the printing head 1 moves relative to the printing bed 6. If the printing material is the first material spool 321 and the second material spool 322 of the wire-shaped material coil roll, the first material spool 321 and the second material spool 322 are arranged on the platform frame 30 of the material platform 3, and the platform frame 30 drives the first material spool 321 and the second material spool 322 to rotate following the rotation of the nozzle seat 12 of the printing head 1, so that the first printing material filament 2a, the second printing material filament 2b or the wire second portion 852 are prevented from being excessively twisted with each other, or excessive winding between the first feeding pipe 241 and the second feeding pipe 242 or with the wire second portion 852 is avoided. The material spool may also rotate around its own axis to continuously provide printing filament material to the print head 1 during the process of printing and extruding printing material from the curled material spool, the printing material filament of the wound material coil is unwound and sent out to continuously provide printing material filament to the printing head. The first printing material filament 2a and the second printing material filament 2b are respectively conveyed to the extrusion opening 1201 and the second extrusion opening 1202 by the first material spool 321 and the second material spool 322, and the first printing material filament and the second printing material filament may also be respectively conveyed to the extrusion opening and the second extrusion opening from the first feeding pipe 241 and the second feeding pipe 242. The first feeder 511 and the second feeder 512 may also be arranged on the feeding path, and the feeders 511 and 512 may be arranged on the platform frame 30 of the material platform 3 or the nozzle seat 12 of the printing head 1. The feeder for the filament may be referred to as an extruder or a filament feeder, and may adopt a tooth type wheel-driven filament conveyer or a wind conveyor or other manners of driving a filamentous printing material and the like.

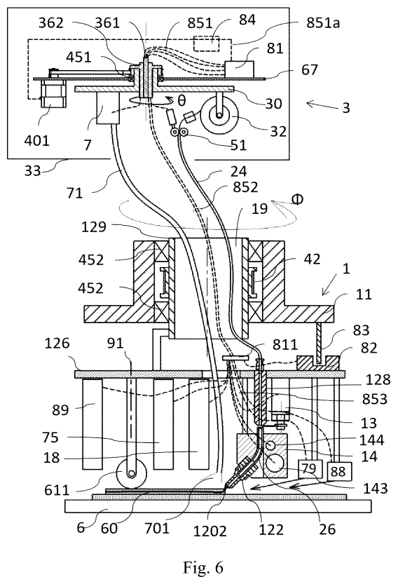

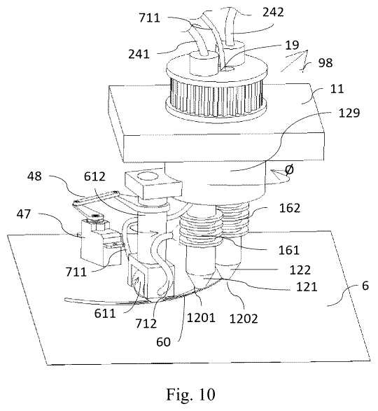

As shown in FIG. 1 to FIG. 7, FIG. 8, FIG. 9, FIG. 11, and FIG. 14, a conductive slip ring 36 (a sliding electrical connection device) may also be used to electrically connect a non-rotating wire first portion 851 with a rotating wire second portion 852, and maintain a corresponding conductive connection between a wire first portion 851 connected to the controller 81 and a wire second portion 852 rotating with the platform frame 30, for example, when the controller 81 may be kept not rotating, the wire second portion 852 and the wire third portion 853 on the printing head 1 respectively follow the platform frame 30 and a first feeder 511 and a second feeder 512 mounted on the material platform), and an electrical component (such as a first heater 1431 and a second heater 1432, a cooling fan 18, a detector 89, an ink jet head 78, etc.) on the nozzle seat 12, and further electrically connected to a rotation angle sensor (82-1 and 83-1, 82-2, and 83-2) used for sensing a rotating zero position or a rotation angle. In FIG. 3, FIG. 4, FIG. 6, FIG. 7, FIG. 9, FIG. 10 and FIG. 11, the second material spool 322 is a fiber material spool, the fiber printing material is conveyed to a second extrusion opening 1202 on the nozzle seat 12 through a second feeding pipe 242 to be extruded onto the printing bed 6, the fiber conveying line is further provided with a cutter 13 arranged on the nozzle seat and used for cutting off the fiber printing material filament, and the wire connecting through the conductive sliding ring 36 on the platform frame 30 may also be electrically connected with a cutter 13 rotating with the nozzle seat 12. The cutter 13 is provided with a cutting knife, the material-pipe-end 128 or the second material-pipe-end 1282 is provided with a notch, and the cutting knife is arranged at the position corresponding to the notch so as to cut off the continuous fiber printing material according to a instruction. The cutter may also be reset so that the continuous fiber printing material may continue to be conveyed and the cutter is in the pre-cutting position to prepare for the next cutting of the continuous fiber printing material. It may be understood that, in some other embodiments, a cutter in other prior art may be used, which is not limited herein.

Specifically, the multi-nozzle 3D printing system shown in FIG. 2, FIG. 3, FIG. 4, FIG. 5, FIG. 7 or FIG. 11 comprises a printing head 1, a material platform 3 and a printing bed 6. The printing head 1 comprises a printing seat 11 and a nozzle seat 12. The nozzle seat 12 may rotate relative to the printing seat 11. The material platform 3 comprises a platform frame 30. The first material spool 321 and the second material spool 322 which are wound with a filament in FIG. 2 may rotate around the axis of the platform frame 30. The platform frame 30 may rotate around the axis 910 (the axis 910 may pass through the platform frame 30). The axis 910 in FIG. 1 and FIG. 2 may be parallel to the axis 910. Due to the fact that the material platform and the nozzle seat are connected through a flexible line, such as a feeding pipe (conveying line), a wire or an blast pipe and the like, no rigid connecting mechanism exists, and the flexible line may adapt to the angle between the material platform and the nozzle seat or the included angle between the two axes through elastic deformation. Preferably, the material platform is arranged right above the printing head, the rotating axis of the material platform is parallel to the rotating axis of the nozzle seat (the included angle is 0, the error is not greater than +−30 degrees), the flexible line is conveyed to the printing head from top to bottom through the material platform, the line is short, smooth transmission to the printing head is achieved in combination with the gravity printing material, the printing material may be arranged in the upper space of the printing head, and the footprint of the 3D printer may be reduced. A first printing filament 2a of the first spool 321 is conveyed to a extrusion opening 1201 on a nozzle seat 12 of the printing head 1. A second printing filament 2b of the second spool 322 passes through the nozzle seat 12 from top to bottom of the nozzle seat 12 and then reaches the extrusion opening 1201 and the second extrusion opening 1202 and is extruded onto the printing bed 6 to form a stacking model 60. The gap between the printing head 1 and the printing bed 6 is increased by a preset distance, such as a layer thickness distance. A first feeder (or an extruder) 511 may also be arranged between the first material spool 321 and the printing head 1 and used for conveying the first printing material filament 2a from the first material spool 321 to the first nozzle 1201, and a second feeder (or an extruder) 512 may also be arranged between the second material spool 322 and the printing head 1 and used for conveying the second printing material filament 2b from the second material spool 322 to the second nozzle 1202. The first feeder 511 and the second feeder 512 may be disposed on the print head 1, for example, respectively fixedly connected to the nozzle seat 12. Certainly, the first feeder 511 and the second feeder 512 may also be arranged on the material platform 3, for example, fixedly connected with the platform frame 30 and rotate together with the platform frame 30. In various embodiments, the extrusion opening 1201 and the second extrusion opening 1202 may be combined together to form one extrusion opening, for example, as shown in FIG. 5.

The material platform 3 may be driven to rotate following the rotation of the nozzle seat 12 through twist torsion of a flexible line such as a printing material filament or a feeding pipe or a wire harness (a wire) through rotation of the nozzle seat 12. For example, rotation of the nozzle seat 12 may be adopted, and the platform frame 30 may be driven to rotate in a follow-up mode through the first printing material filament 2A or the second printing material filament 2B or through the first feeding pipe 241 or the second feeding pipe 242. As shown in FIG. 1, FIG. 2, FIG. 3, FIG. 6, FIG. 7, FIG. 11 or FIG. 14, a single first motor 401 is adopted to drive the platform frame 30 to rotate through a synchronous belt 41-a or a gear 473. Further, as shown in FIG. 3, FIG. 11 or FIG. 14, the rotating instruction for controlling the nozzle seat 12 sent by the controller 81 may also be transmitted to the first motor 401, and for a high-frequency small-angle rotation of the nozzle seat 12, the material platform 3 may be not fully following the rotation of nozzle seat 12, so that the filtering module 84 may be further arranged to filter the rotating instruction, the rotation of the material platform 3 is smoother, and the vibration and energy consumption of the whole equipment may be reduced. It should be noted that the filtering module 84 may be an electronic device, or may be a software module (for example, a computer program capable of running on the controller 81), for example, filtering by using a sliding average algorithm, and filtering an instruction sent to a driving material platform of the first motor 401, that is, the filtering module 84 may also be integrated into the controller 81 (for example, in a software system thereof), and the filtering assembly is used for filtering a high-frequency and/or small-angle rotating signal corresponding to the nozzle seat in a signal sent by the control module to the material platform and controlling the platform frame to rotate, so that the platform frame rotates in the corresponding direction following the rotation of the nozzle seat when the rotating angle of the nozzle seat is greater than a preset angle value. Therefore, an instruction for controlling the rotation of the material platform 3 by the controller 81 is an instruction after filtering processing. Therefore, high-frequency dynamic rotation information in the instruction may be filtered out, the material platform 3 does not rotate when the rotation angle of the nozzle seat 12 of the printing head 1 is smaller than a preset value, the material platform may rotate in the corresponding direction only when the rotation angle of the nozzle seat 12 of the printing head 1 is larger than a preset value, the material platform may rotate at a small angle in a small-angle range, and when the nozzle seat 12 continuously rotates in a certain direction (such as clockwise or anticlockwise), the material platform 3 may keep continuous rotation of the corresponding rotating speed. The rotating angular acceleration of the material platform 3 is smaller than a preset value, and the optimal angle is smaller than the angular acceleration of the nozzle seat 12. In this way, the influence of the large-quality material platform 3 on the dynamic performance of the nozzle seat 12 may be avoided, the rotating angle of the nozzle seat 12 may be not limited, and the nozzle seat 12 may rotate at any angle. The material platform 3 may also move following the moving of the printing head 1, and certainly, the movement of the nozzle seat 12 and the movement of the material platform 3 may be independently carried out respectively, that is, the movement (or rotation) of the material platform 3 and the movement (or rotation) of the nozzle seat 12 do not need to be completely synchronous. Specifically, for example, the printing head 1 moves, the material platform 3 may not move or the material platform 3 moves, the printing seat 11 does not move, certainly, the material platform 3 and the printing seat 11 may move at the same time, the moving speed does not need to be synchronous, and certainly case may be completely synchronously moved. The material platform may not move when position difference between the material platform 3 and the printing head 1 may be smaller than a preset value range, and move in the corresponding direction following the movement of the printing head when the position difference is larger than a preset value, for example, the preset values can be 0 mm, 10 mm, 100 mm, 300 mm, 500 mm, or 1000 mm, etc. The dynamic performance, the printing precision and the printing speed of the printing system may be improved, the printing flexibility may be improved, the degree of freedom of printing path planning is improved, for example, when the slicing software generates a corresponding printing path according to the three-dimensional digital model, the limitation of the rotating angle of the nozzle seat 12 may be not considered, and a printing path of a nozzle (an extrusion opening) or a multi-nozzle (equivalent to a multi-extrusion opening) may be freely or more optimized.

In addition, it should be noted that the following features may be common features of all embodiments: the platform frame 30 of the material platform 3 is rotatable; the printing head 1 comprises a printing seat 11 and a nozzle seat 12, the nozzle seat 12 may rotate relative to the printing seat 11, and the printing head is provided with at least one nozzle (equivalent to an extrusion opening or an hot end with an extrusion opening) or a plurality of nozzles (equivalent to an extrusion opening or an extrusion opening at the hot end); and the material platform 3 sends the printing material to the printing head 1. Descriptions in some embodiments may not be repeated.

Another printing system is illustrated in FIG. 8. The printing material is a granular material rather than a filamentous printing material or wire or fiber. The material platform 3 is provided with a first pumping device 521 and a second pumping device 522. For example, the pumping device may use a screw extruder, for example, a granular printing material such as a resin may be heated to form a molten printing material and pressurize, and certainly, a device for pumping a flowable material (such as mud, chocolate slurry, etc.) may also be used. The particle printing material 23 is sent to a first pumping device 521, heated and melted, and extruded and pressurized by a screw rod. The particle printing material 23 is sent to a extrusion opening 1201 of a nozzle seat 12 through a first feeding pipe 241 for extrusion. The particle printing material 23 is sent to a second pumping device 522 to be heated and melted and extruded and pressurized by a screw rod. The particle printing material 23 is sent to a second extrusion opening 1202 of the nozzle seat through a feeding pipe 242 for extrusion. A first valve 151 may be further arranged on the first material-pipe-end 1281 and used for controlling the extrusion speed of the molten printing material at the extrusion opening 1201, and a second valve 152 may be further arranged on the second material-pipe-end 1282 and used for controlling the extrusion speed of the molten printing material at the second extrusion opening 1202. The first heating block 141 on the first material-pipe-end 1281 and the second heating block 142 on the second material-pipe-end 1282 are optional and may be used for further adjusting the temperature of the molten printing material at the extrusion opening. In order to maintain the temperature of the molten printing material in the feeding pipe, the accompanying heating part may be arranged on the feeding pipe, for example, the first feeding pipe 241 (such as the outer side) may be provided with the accompanying first heating winding wire 5521 (which may be arranged in a winding mode), and the accompanying second heating winding wire 5522 (which may be arranged in a winding mode) may be arranged on the second feeding pipe 242 (such as the outer side). The first heating winding wire 5521 and the second heating winding wire 5522 are electrically connected to the controller 81 through the conductive sliding ring 36 through the second wire portion 852 a and the second wire winding wire 5522 respectively, so that the temperature of the molten printing material in the feeding pipe is controlled. Of course, the accompanying heating part may also be an accompanying heating core, and the heating core is arranged in the first feeding pipe 241, so that the melting printing material in the first feeding pipe 241 may be heated more easily. When printing is completed, the molten printing material in the feeding pipe may be blown out by using compressed gas firstly, and then heating is stopped. Of course, the second pumping device 522 may also be replaced with the fiber material spool 32 in FIG. 6, and the fiber filament material provides a fiber printing material for the second extrusion opening 1202 through the second feeding pipe 242. The second extrusion opening may also be obliquely disposed toward the extrusion opening.

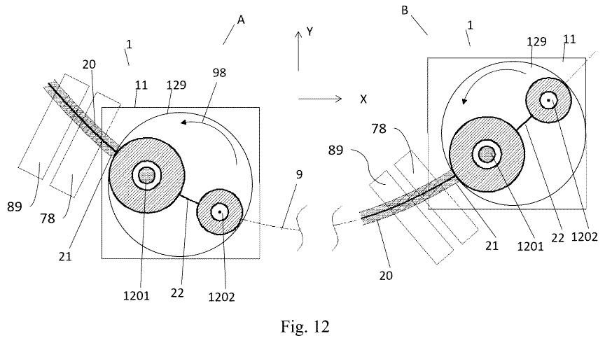

As shown in FIG. 9, the pumping device 52 is arranged on the nozzle seat of the printing head 1 (for example, fixedly connected with the nozzle seat ring 129) and may rotate together with the nozzle seat 12 (or the nozzle seat ring 129). The pump pressure device 52 adopts a screw extruder, such as a screw extruder similar to the one in an injection mold, and may heat and pressurize the particle resin material. A extrusion opening 1201 is formed at the bottom of the pumping device 52, so that the material may be extruded at the extrusion opening 1201. When the printing material is a flowing printing material, the feeding device comprises a feeding container (such as a funnel 57), the feeding container is provided with a discharging port, and the feeding container is used for containing flowing printing materials so as to convey flowing materials to the extruding opening. The funnel 57 may be fixedly connected to the platform frame 30 and may rotate together with the material platform 3. The funnel 57 is communicated with the pumping device 52 through a first feeding pipe 241. A particle printing material 23 is contained in the funnel 57, is conveyed to the feeding port of the pumping device 52 through the first feeding pipe 241, is heated by the pumping device 52 and pressurized by the screw to form molten printing material and then is extruded onto the printing bed 6 through the extrusion opening 1201 to form the printed model 60. it may also be provided with a pump device 58 on the funnel 57 to accelerate or regulate the conveying of the particle printing material 23 to the pumping device 52. The pump device 58 may be arranged at the bottom of the funnel 57 to be communicated with the first feeding pipe 241, and certainly, the pump device may also be arranged in the funnel 57 and is not directly communicated with the feeding pipe 57, and the first feeding pipe 241 is directly communicated with the bottom of the funnel 57. And a feeding port of the pumping device 52 may also be disposed directly above the pumping device 52, for example, a first synchronous pulley 42-1 may be disposed above the pumping device 52 and coaxially and fixedly connected to a screw of the pumping device 52, and a feeding port of the pumping device 52 may be fed to the pumping device 52 passing through the first synchronous pulley 42-1. The motor 40 may be fixedly connected with the nozzle seat ring 129, and the first synchronous belt 42-1 and the first synchronous pulley 42-1 are driven by the second synchronous pulley 42-2 and the synchronous belt 41 to drive the screw rod of the pump pressure device 52 to rotate. For example, the screw rod may be arranged in the first material-pipe-end 1281, the first material-pipe-end 1281 may be regarded as a shell of the pumping device 52, and a first heater 1431 formed by winding a heating coil may also be arranged on the outer side of the first material-pipe-end 1281. A material spool 32 may also be provided on the material platform, for example, by using a continuous fiber printing material, conveyed to a second feeding pipe 242 through a feeder 51, then conveyed to a second material-pipe-end 1282, and finally conveyed to a second extrusion opening 1202 for extrusion. This may be used to print a composite model with continuous fibers. The cutter 13 arranged at the second material-pipe-end 1282 may be used for cutting off the continuous fiber printing material according to a preset requirement, and the optimal second extrusion opening inclines towards the extrusion opening 1201. In FIG. 12, the first feeding pipe 241 and the second feeding pipe 242 both pass through the through hole 19 of the nozzle seat ring from top to bottom and then are respectively connected to the feeding port of the pumping device 52 and the second material-pipe-end 1282, and both the pumping device 52 and the second material-pipe-end 1282 may be fixedly connected with the nozzle seat ring 129 below the nozzle seat ring 129, so that the diameter of the nozzle seat ring is reduced, and the arrangement of the pumping device 52 and the second material-pipe-end 1282 is facilitated. The heavy granular material, the granular material, the pump device and the like are all arranged on the material platform 3 instead of the printing head 1. The printing head 1 is simple and light in structure while being printing by using the particle printing material, so that the printing head has the characteristics of small mass and low inertia, and the printing precision, the printing speed and the dynamic performance are improved.

Taking two extrusion openings as an example to illustrate the specific printing process, let the first extrusion opening 1201 and the second extrusion opening 1202 move along the first printing path and the second printing path, respectively, the nozzle seat 12 rotates relative to the printing seat 11. The extruded printing material forms a printed model 60 on the printing bed 6. In this way, multi-nozzle parallel simultaneous printing may be achieved. In the printing process, due to the follow-up rotation of the material platform 3, the nozzle seat 12 may realize rotation freedom of the nozzle seat 12 in the parallel printing process of the multiple nozzles, so that the flexible and freedom degree of the design of the printing process path or the design of the control software is greatly improved, and the printing speed and the printing precision are improved. If the second material spool 322 is a fiber material spool, the second extrusion opening 1202 of the extruded fiber may move along the same printing path with, or the two extrusion openings may both move along the same printing path, or the two extrusion openings may be simultaneously printed on two parallel printing paths arranged side by side and close to each other, so that the fiber printing material 22 extruded by the second extrusion opening 1202 reaches the printing bed 6, and then the flowable printing material (such as a filamentous or granular meltable resin material or slurry or photosensitive resin liquid or slurry) extruded by the extrusion opening 1201 is stacked on the fiber printing material 22 to form a composite printing material to form a model with composite material. As shown in FIG. 12, when the printing seat 11 moves along the printing path 9, the nozzle seat 12 drives the extrusion opening 1201 and the second extrusion opening 1202 to rotate, and as shown by arrow 98, in the relative movement process of the printing head 1 and the printing bed 6, for example, the printing head 1 moves from the position A to the position B, it may be ensured that the two extrusion openings are always located on the printing path 9 by rotation of the nozzle seat 12. When the rotation angle of the nozzle seat 12 is small, for example, less than 90 degrees, 180 degrees or 360 degrees, the winding of the multi-filament material (printing material filament), or the multi-feeding pipe or the feeding pipe and the wire harness may be absorbed by the elasticity of the filament, the feeding pipe or the wire harness, or when the rotating angle is too large, for example, continuous multiple circles rotation (such as more than one circle or more than two circles, the number of turns may be different according to actual conditions), or the winding between the feeding pipe and the wire harness is too large to affect filament conveying process, or the printing material filament is broken, the feeding pipe or the wire harness is damaged, and the nozzle seat may not further rotate more turns or affects the printing precision due to winding torque is too large. According to the printing method, the printing material is sent to the nozzle seat 12 of the printing head from the rotatable material platform 3, so that the printing material, the feeding pipe or the wire harness may rotate in the same direction of the rotation of the nozzle seat 12 by rotation of the material platform 3, the winding angle between at least any two of the printing material, the feeding pipe or the wire harness and the like may be always kept smaller than a preset value, the preset values may be 0 degrees, 90 degrees, 120 degrees, 180 degrees, or 360 degrees, and even winding may be eliminated, so that the rotating degree of freedom of the nozzle seat 12 may be greatly improved. For example, in the printing process of multiple circles of printing paths, the nozzle seat 12 may always keep the two extrusion openings to be located on the corresponding printing paths through continuous circular rotation, and meanwhile, the material platform 3 rotates along with (following the rotation of) the nozzle seat 12, so that the winding problem between the printing material or the feeding pipe or between the printing material or the feeding pipe and the wire harness is avoided. Or for example, the printing path is spiral shaped with multiple consecutive turns (such as more than 1 or more than 2 turns) and stacked along the Z-axis. In the printing process, the printing bed 6 and the printing head 1 may be continuously rotated while the nozzle seat 12 rotates continuously, for example, the printing bed 6 may continuously move away from the printing head, so that multiple extruding openings may continuously print multiple circles of spiral paths at the same time, and no winding or small winding among the printing materials, the feeding pipe and the wire harness may still be kept due to the fact that the material platform 3 rotates following the rotation of the nozzle seat 12. In general, the printing process is smoother and more continuous, the nozzle seat 12 may rotate by any number of turns, continuous following printing may be carried out on any number of turns (vortex or spiral) printing paths, and in the number of rotating turns, the rotating torque or rotating resistance of the nozzle seat 12 is generally uniform and consistent, so that the stability, rapidity and accuracy of the printing process are improved. In this way, the reliability of the system and the simplicity of a software control algorithm are also improved.

Referring to FIG. 7, there may be three extrusion openings printing at the same time, that is, three material spools may be arranged on the material platform 3, for example, the first material spools 321 with a first material spool 321 provided plastic filament, the other two material spools are provided with a second material spool 322 and a third material spool 323 which are provided with continuous fiber filaments, three feeders are further arranged on the material platform. The first feeder 511 delivers the printing material from the first spool 321 to the first extrusion opening 1201 through the first feeding tube 241, the second feeder 512 delivers the continuous fiber material from the second spool 322 to the second extrusion opening 1202 through the second feeding tube 242, and the third feeder 513 delivers the continuous fiber material from the third spool 323 to the third extrusion opening 1203 through the third feeding tube 243. the first extrusion opening 1201 is formed in the first nozzle portion 121, the second extrusion opening 1202 and the third nozzle portion 1203 are arranged at the second nozzle portion 122, and the second nozzle portion 122 may also incline towards the direction of the extrusion opening 1201. It may be understood that in other optional embodiments, the continuous fiber filaments may be conveyed in a manner such as (hot) air blowing in addition to being conveyed through the second feeder 512 and the third feeder 513. The nozzle seat 12 drives the extrusion opening 1201, the second extrusion opening 1202 and the third extrusion opening 1203 to rotate relative to the printing seat 11. Meanwhile, the second nozzle portion 122 or the second extrusion opening 1202 and the third extrusion opening 1203 may also rotate relative to the nozzle seat 12, so that the three extrusion openings simultaneously extrude the printing material along respective corresponding printing paths, and meanwhile, the three feeders on the material platform 3 rotating in the same direction of the rotation of the nozzle seat 12 send printing materials to the three extrusion openings, so that excessive winding among the printing wire material, the feeding pipe or the wire harness (wire) may still be avoided, and although the second extrusion opening 1202 and the third extrusion opening 1203 also rotate relative to the nozzle seat 12, the second extrusion opening 1202 and the third extrusion opening 1203 only need to be adjusted at a small angle relative to the nozzle seat 12, so that the torsion is relatively small, the feeding function of the feeding pipe is not influenced, the nozzle seat 12 may still be continuously and continuously rotated to follow the situation of multiple circles of printing paths, and the continuous and smooth rapid parallel printing process of multiple nozzles is achieved. The two continuous fibers may be extruded with the printing material filament at the same time, a larger fiber content percentage is facilitated, the strength of the printed model 60 is improved, and the printing speed of the model is also increased.

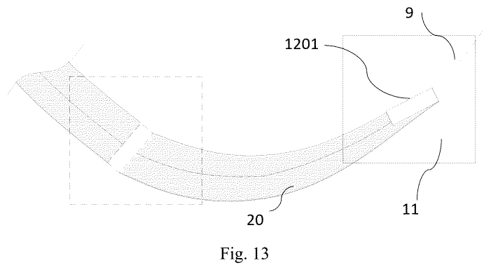

In all embodiments of the present invention, one nozzle or one extrusion opening, such as shown in FIG. 1, FIG. 6, or FIG. 14, may also be employed on the nozzle seat 12 on the printhead 1. In the printing process, by the rotation of the nozzle seat 12, the extrusion opening may be kept to extrude the printing material on the fixed side edge, and if the printing material may be kept to be extruded at the fixed side edge of the extrusion opening, the discharging is smoother, that is, the printing material may flow flat or smoothly flow out in the extrusion process, due to changes in the direction of the print head movement and the absence of nozzle holder 12 rotation, the print material may “fold” during extrusion and experience uneven extrusion, and especially when the printing material is resin material and short fibers are mixed in it, it is even more so. In addition, the fixed side edge of the extrusion opening may be low, the fixed side edge may be kept at the rear position along the movement direction of the printing head all the time by rotation of the nozzle seat 12 in the printing process, for example, the shape of the extrusion opening may be higher in the front and lower in the back, the fixed side edge may be used for pressing the just extruded printing material, and the extruded printing material is more tightly combined with the previously extruded printing material. The cross section of the extrusion opening may also be formed into a non-circular shape, such as a rectangle, a rectangle with rounded corners, a long waist shape, an oval shape, a triangle and the like. As shown in FIG. 13, the printing head in the printing system adopts an extrusion opening 1201. The long edge of the extrusion opening 1201 and the tangent line at the corresponding point of the printing path 9 right below the extrusion opening may be controlled to maintain or adjust the width of the extrusion printing material, and the just extruded printing material 20 extruded on the platform is cured to form the model 60, for example, in the printing process, as long as the angle between the long side of the extrusion opening 1201 and the tangent line at the corresponding point of the printing path 9 directly below the extrusion opening 1201 is not changed, the extrusion width of printing material 20 may be flexibly obtained as long as the angle is kept, for example, when the angle is adjusted in the 90-degree direction, the width of the printing material is increased, when the angle is adjusted in the 0-degree direction, the width of the extrusion printing material is reduced, the printing material moves along the printing path of the printing head, and the angle is adjusted in the 0-degree direction by rotation of the nozzle seat, so that the width of the extruded printing material 20 is gradually reduced. Preferably, the orthographic projection of the section center point of the extrusion opening 1201 to the plane where the printing path 9 is located coincides with the printing path 9. In addition, in the case of a multi-extrusion opening, the non circular extrusion opening may be arranged at the lower end position of the second nozzle portion 122 in FIG. 7, and the angle between the long edge of the non circular extrusion opening and the tangent line at the corresponding point of the printing path 9 right below the extrusion opening may be adjusted by rotation of the second nozzle portion 122 around the axis of the second nozzle portion 122. Due to the fact that the nozzle seat drives the material-pipe-end and the extrusion opening to rotate, meanwhile, the feeding pipe and the material platform above may rotate following the rotation of the nozzle seat, so that in the rotating process of the nozzle seat, the printing material keeps the whole rotating state of the nozzle seat from the conveying process of the feeding pipe to the extrusion opening, the feeding and melting extrusion process is not affected by rotation of the nozzle seat, and the feeding and extrusion process is more stable and reliable. It can also avoid avoidance or interference between electrical components or with heat dissipation fins/heaters.

Specifically, as shown in FIG. 1, FIG. 6 or FIG. 14, only one extrusion opening (nozzle) is provided on the nozzle seat, and only one material spool 32 and one corresponding feeder 51 are provided on the platform frame 30. The feeder 51 may pass through the through hole 19 of the nozzle seat 12 to be communicated with the extrusion opening 1201, for example, the material pipe end 128 is fixedly connected to the nozzle seat ring 129 (not shown in the Figure). When the printing head moves along the printing path for printing, the nozzle seat ring 129 may drive the extrusion opening 1201 to rotate, so that a certain side edge of the extrusion opening 1201 is kept behind in the moving direction of the nozzle seat 12, so that the printing material flows out of the process to be smooth, the printing material is prevented from being folded during extrusion, the side edge of the extrusion opening 1201 may be lower, as shown in FIG. 1, extrusion of the extrusion printing material may be pressed, and the bonding strength between the printing material layers is improved. Alternatively, the extrusion opening 1201 is omitted in FIG. 6, the material spool 32 and the feeder 51 are arranged on the platform frame 30 and rotate together with the platform frame 30, the feeding pipe 24 conveys the printing material output by the feeder 51 to the material pipe end 128 of the printing head 1, and the printing material is conveyed to the second extrusion opening 1202, and the second extrusion opening is obliquely arranged. In the printing process, the second extrusion opening 1202 may be kept inclined towards the rear along the moving direction of the nozzle seat (or the printing head 1) by rotation of the nozzle seat (rotation of the nozzle seat ring 129), so that the printing material may be extruded more smoothly, for example, when the printing material is a continuous fiber filament material, the bending angle is smaller when the continuous fiber filament material is extruded by the second extrusion opening 1202, the extrusion is smoother, and the damage possibility is reduced.

As shown in FIG. 14, the nozzle seat 12 comprises a nozzle seat ring 129 and a swing arm 127 which pass through the through hole 19. The swing arm 127 is connected to the nozzle seat ring 129. The extrusion opening 1201 is provided on the swing arm 127, for example, is connected to the swing arm 127 by means of the first nozzle portion 121. The extrusion opening 1201 may move along the guide rail 43. In this way, the printing seat 11 moves along the guide rail 43 and the rotation of the nozzle seat 12 relative to the printing seat 11 to drive the swing arm 127 and the extrusion opening 1201 to rotate together. When the nozzle seat 12 drives the swing arm 127 to rotate, the material platform 3 may drive the material spool 32 to rotate following the rotation of the nozzle seat 12, so that the feeding pipe 24 or the wires 852 and 853 may not be wound, the feeding pipe 24 may avoid interference with the nozzle seat ring 129, and interference with the guide rail 43 or the synchronous belt may be avoided, the swing arm 127 may rotate at any angle, and a more free and smooth printing process is achieved. A third feeder (extruder) 513 may also be provided on the nozzle seat 12, and a third feeder (extruder) 513 may be driven by the second motor 402 through the synchronous belt 41-c so that the third feeder (extruder) 513 may drive the printing material to be conveyed to the extrusion opening 1201, and the second motor 402 may be arranged at the nozzle seat ring 129 to reduce the overall rotational inertia of the nozzle seat 12. In conclusion, the platform frame drives the material spool 32 and the feeder 51 to rotate with the nozzle seat, so that excessive twisting or excessive winding of the feeding pipe 24 may be effectively avoided, or excessive winding between the feeding pipe 24 and the wire or excessive winding with the blast pipe (air supply pipe) 71 may be avoided.

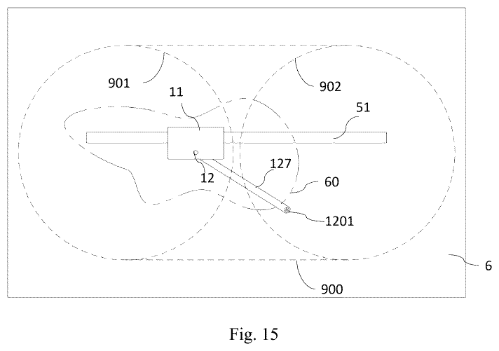

Further, referring to FIG. 15, the stroke of the printing seat 11 moving along the guide rail 43 is greater than or equal to twice the rotation radius of the extrusion opening 1201 around the rotation axis (the first axis) of the nozzle seat. Under the combined action of the movement of the printing seat 11 and the rotation of the swing arm 127 driven by the nozzle seat 12, the printing head can form a long elliptical printing area 900 without any blind area on the printing platform 6. When printing, the swing arm 127 rotates relative to the printing seat 11 through the nozzle seat 12, and the first axis of the nozzle seat 12 can be fixed on the printing seat 11. When the printing seat 11 moves along the guide rail 43, two extreme positions may be formed at the two ends, and when the printing seat 11 moves to the first end, for example, the leftmost end in FIG. 15, the swing arm 12 rotates by one circle relative to the printing seat 11 through the nozzle seat 12, and then the movement path of the extrusion opening 1201 forms a first limit circle 901; and when the printing seat 11 moves to the second end, for example, the rightmost end in FIG. 15, the swing arm 12 rotates by one circle relative to the printing seat 11 through the nozzle seat 12, the movement path of the extrusion port 1201 will form a second limit circle 902. so that the printing area 900 may be divided into three parts, namely a first limit circle area, a second limit circle area, a area between the first limit circle and the second limit circle, the first limit circle area comprises an area within the first limit circle 901 and a circle contour of the first limit circle 901, and the second limit circle area comprises an area within the second limit circle 902 and a circle contour of the second limit circle 902. When the moving distance of the printing seat 11 along the guide rail 43 is less than twice the rotation radius (the radius of the swing arm 12) of the extrusion opening 1201 around the first axis (the rotation axis of the nozzle seat 12), then the first limit circle 901 and the second limit circle 902 will create an intersection area, which is the printing blind area, in this situation, no matter how the printing seat 11 moves along the guide rail 43 and how the swing arm 127 swings, the extrusion opening 1201 may not reach the printing blind area, this creates a printing blind area inside the printing area 900 that cannot be printed, which is not conducive to the laying of the model to be printed on the printing platform 6 and greatly reduces the actual size of the printable model, for example, for the to-be-printed model 60, if a part of the model is located in the printing blind area, the part may not be printed and formed. When the movement distance of the printing seat 11 along the guide rail 43 is greater than or equal to twice the rotation radius (the radius of the rotation axis of the nozzle seat 12) of the extrusion opening 1201 around the first axis (the rotation axis of the nozzle seat 12), as shown in FIG. 15, the first limit circle 901 and the second limit circle 902 do not generate intersection areas, but are in contact with or separated from each other, so that the printing blind area is eliminated, and the extrusion opening may be driven to reach all areas in the printing area 900 by the movement of the printing seat 11 and the swing of the swing arm 127. The extrusion opening 1201 may be freely printed in the printing area 900, meanwhile, the material platform 3 rotates with the nozzle seat 12, so that the conveying line may not be excessively wound, the extrusion opening 1201 may freely rotate at any angle around the first axis, the printing speed and precision are better improved, and the control process of the movement position of the extrusion opening 1201 may also be simplified.

Alternatively, the print head can be equipped with two material pipe end that transport both printing materials to the same extrusion opening, as shown in FIG. 5. Two material spools can also be installed on the platform frame 30, such as the first tray 321 and the second tray 322, which are respectively fed into the first feeding tube 241 and the second feeding tube 242 through the first feeder 511 and the second feeder 512, and then transferred to the first material pipe end 1281 and the second material pipe end 1282. The first material pipe end 1281 and the second material pipe end 1282 are then transferred to the same extrusion opening, namely the first extrusion opening 1201, through the first nozzle portion 121 and the second nozzle portion 122, respectively, which is equivalent to the second extrusion opening 1201. The second extrusion opening 1202 is merged (integrated) into the first extrusion opening 1201. For example, if the printing material conveyed by the second nozzle portion 122 is continuous fiber filament material and the printing material conveyed by the first nozzle 121 is meltable resin material, then both are extruded simultaneously at the extrusion opening 1201. A notch can also be set on the second material pipe end 1282, similar to FIG. 4, and a cutter 13 can be installed to cut the continuous fiber material according to instructions. It is also possible to make the feeding pipeline in the first nozzle portion 121 not inclined but vertically downward, and to align the axis of this vertically downward feeding pipeline with the rotation axis of the nozzle seat (the first axis coincides). Ideally, during the printing process, keep the second nozzle portion 122 tilted towards the rear in the direction of the print head movement (as indicated by the arrow x in the Figure), so as to maintain a smoother extrusion of the continuous fiber material. Similarly, by driving the first spool 321, the second spool 322, the first feeder 511, and the second feeder 512 to follow the rotation of the nozzle seat through the platform frame, excessive winding between the first feeding tube 241 and the second feeding tube 242 can be effectively avoided. The first nozzle portion 121 can be regarded as a part of the first material pipe end 1281, and the second nozzle portion 122 can be regarded as a part of the second material pipe end 1282.

FIG. 2, FIG. 3, and FIG. 4 specifically illustrate the rotatable connection of the platform frame 30 to the base frame 67, for example, the first bearing 451 is installed between the platform frame 30 and the base frame 67. The first spool 321, the second spool 322, and the corresponding first feeder 511 and second feeder 512 are all set on the platform frame 30. The first feeder 511 is provided with a first feeding tube 241 to the nozzle seat, and the second feeder 512 is provided with a second feeding tube 242 to the nozzle seat 12. The first filament 2a provided by the first spool 321 is conveyed to the first extrusion opening 1201 through the first feeding tube 241, and the second filament 2b provided by the second spool 322 is conveyed to the second extrusion opening 1202 through the second feeding tube 242. In order to achieve electrical connection, a conductive slip ring 36 is also provided. The conductive slip ring 36 includes at least two parts that can rotate relative to each other, and multiple conductive connections can be made between these two parts, such as through metal spring plates or electromagnetic induction. This allows one part to be connected to the base frame 67 and the other part to the material platform frame 30, achieving a circuit connection from the non rotating base frame 67 to the rotatable platform frame 30. In the various Figures of the present invention, the dashed lines connected to the conductive slip ring 36 represent wire harnesses (wires). For example, the controller 81 can be set on the base frame 67, electrically connected to a part of the conductive slip ring 36 (such as the first conductive slip ring part (first conductive slip ring portion) 361) through the first portion 851 of the wire, and electrically connected to another part of the conductive slip ring 36 (such as the second conductive slip ring part (second conductive slip ring portion) 362) on the side of the platform frame 30. The corresponding circuits between the first portion 851 and the second portion 852 of the wire are electrically connected, and the non corresponding circuits are insulated. The second portion 852 of the wire can supply power to the electrical components on the material platform 3, such as to the motors of the first feeder 511 and the second feeder 512. The first sensor 82-1 is installed on the feeding platform frame 30, and the first sensing component 83-1 is fixedly connected to the base frame 67. This allows the second portion 852 of the wire to provide a circuit connection for the first sensor 82-1, which can be used to detect the zero position or angle of rotation of the feeding platform frame 30. Of course, the first sensor 82-1 can also be mounted on the base frame 67, and the first sensing component 83-1 can be fixedly connected to the platform frame 30. In this way, the first sensor 82-1 can be directly connected to the controller 81 through wires. The wiring harness is transmitted to the print head 1, and the part of the wiring harness that is transmitted to the print head is represented by the third portion 853 of the wire. The third portion 853 of the wire supplies power to the electrical components on the nozzle seat 12, such as the first heater 1431 on the first heating block 141, the second heater 1432 on the second heating block 142, the first and second cooling fans 171 and 172, etc. The first cooling fan 171 blows and dissipates heat to the first heat sink 161, and the second heat sink 172 blows and dissipates heat to the second heat sink 162. Of course, only one cooling fan can be used to dissipate heat to both heat sinks. In addition, the second sensor 82-2 is installed on the nozzle seat 12 and can rotate together with the nozzle seat 12, while the second sensing component 83-2 that triggers sensing is installed on the printing seat 11. This can provide the corresponding circuit in the third portion 853 of the wire to the second sensor 82-2, which can be used to detect the zero position or rotation angle of the nozzle seat 12. The nozzle seat 12 may also be provided with through holes for flexible lines to pass through. At least one flexible circuit may pass through the through hole. The nozzle seat 12 may further include a nozzle seat ring 129 and a material pipe end 128 (which may further include a first material pipe end 1281 and a second material pipe end 1282). The nozzle seat ring 129 has a through hole 19 to form the aforementioned through hole. For example, the first material pipe end 1281 and the second material pipe end 1282 pass through the through hole and are respectively connected to the first extrusion opening 1201 and the second extrusion opening 1202. The first heating block 141 and the first heat sink (radiator) 161 can also be installed on the first material pipe end 1281, and the second heating block 142 and the second heat sink (radiator) 162 can also be installed on the second material pipe end 1282. The first material pipe end 1281 and the second material pipe end 1282 can be placed inside the nozzle seat ring 129 and fixedly connected to it (as shown in FIG. 5 and FIG. 8, etc.), or they can be placed below the nozzle seat ring 129 and fixedly connected to it (as shown in FIG. 1 and FIG. 2, FIG. 4, FIG. 6, FIG. 7, FIG. 9, and FIG. 11, etc.). The rotation axis of the nozzle seat ring can be set coaxially with the first axis. A second bearing 452 can be installed between the nozzle seat ring 129 and the printing seat 11, and of course, two bearings can be installed to enhance stability. The print head can move along the XY direction arrow, and the printing bed 6 can move along the Z direction arrow; Of course, it can also be the print head moving along the Z direction, or the printing bed 6 moving along the XY arrow direction. The dashed lines in the diagram representing wires (harnesses) only indicate the connection relationship, and the specific number of wires for each electrical component depends on the actual situation. The heater or temperature sensor can be regarded as a part of the heating block, that is, the heating block (such as the first heating block or the second heating block) can achieve temperature control.

The conductive slip ring 36 includes a first conductive slip ring portion 361 and a second conductive slip ring portion 362 that can rotate relative to each other (around a second axis). Ideally, the conductive slip ring 36 is coaxially arranged with the second axis, which is the rotation axis of the material platform. The first part (portion) of the wire harness 851 on the side away from the print head 1 is connected to the first conductive slip ring portion 361, and the second part (portion) of the wire 852 on the side close to the print head is connected to the second conductive slip ring portion 362. The corresponding circuit between the first part (portion) of the wire 851 and the second portion of the wire 852 is electrically connected through the conductive slip ring 36. In this way, the first conductive slip ring portion 361 can be electrically connected to the controller 81 through the wire harness 851 without rotating, while the second conductive slip ring part 362 can rotate together with the material table frame 30, and the wires it leads out can be electrically connected to the devices on the material platform 3 and/or nozzle seat 12, respectively, for power supply, signal transmission or control. In FIG. 3 or FIG. 6, it is shown that the second conductive slip ring portion (part) 362 can be sleeved on the outside of the first conductive slip ring part 361. FIGS. 4 and 11 illustrate that the second conductive slip ring part (portion) 362 can be sleeved on the inside of the first conductive slip ring part (portion) 361. Of course, the second conductive slip ring part 362 and the first conductive slip ring part 361 can also be arranged coaxially in a stacked manner similar to FIG. 5, as long as they rotate relative to each other and can achieve electrical connection of multiple circuits. The platform frame 30 may include two parts that are fixedly connected to each other, namely the bracket sleeve 302 and the bracket plate. The bracket sleeve 302 can also be sleeved on the outside of the second conductive sliding ring part 362, which can be fixedly connected to the bracket sleeve 302 of the platform frame 30. A bearing 451 can also be installed on the part of the platform frame 30 that is sleeved on the outside of the second conductive sliding ring part 362, that is, on the outside of the platform frame sleeve 302, and connected to the base frame 67 through this bearing 451. In this way, the platform frame 30 rotates relative to the base frame 67 through the bearing 451, and drives the second sliding ring part 362 and the second wire part 852 to rotate together. In FIG. 5, an stacked type conductive slip ring is also illustrated. Of course, the conductive slip ring can also adopt an inductive type, that is, the first conductive slip ring part 361 and the second conductive slip ring part 362 are arranged relative to each other and may not be in contact, and the circuit is connected through electromagnetic induction. Of course, these are only examples and not limitations of the present invention. Material platform 3 may not only include a platform frame 30, a first material spool 321, a second material spool 322, a first feeder 511, and a second feeder 512, but also a first feeding detector 861 and a second feeding detector 862. The first feeding detector 861 and the second feeding detector 862 are respectively set on the feeding line (conveying line) between the first material spool 321 and the first feeder 511 and the feeding line between the second material spool 322 and the second feeder 512, used to detect whether the filament of the first material spool 321 and the second material spool 322 is exhausted. Material platform 3 can rotate relative to the base frame.

As shown in FIG. 4, FIG. 11 and FIG. 14, a central shaft 37 is further included, the central shaft 37 is fixedly connected with the base frame 67, the central shaft 37 may be regarded as a part of the base frame 67, the central shaft 37 and the base frame 67 may be assembled and connected, and the central shaft 37 and the base frame 67 may be integrally formed, as shown in FIG. 11. a bearing 451 is arranged between the platform frame 30 and the center shaft 37, the bearing 451 comprises an outer ring and an inner ring which may rotate relative to each other, the outer ring is fixedly connected with the platform frame 30, and the inner ring is fixedly connected with the central shaft 37. This structure facilitates the placement of the first driving mechanism (such as motor 401, synchronous belt 41-a, and synchronous belt pulley 42-1) that drives the platform frame 30 on the outer side of bearing 451, allowing synchronous belt pulley 42-1 and bearing 45-1 to be stacked along the axis of the material platform 3 in the radial direction. This is beneficial for reducing the size along the axis of the material platform 3, facilitating the arrangement of the first driving mechanism for driving the rotation of the material platform frame, and connecting it to the material platform frame. The material spool or material source device is more easily connected to the material platform frame, and improving the stability of the connection structure. The central shaft 37 may be used as a connection interface for the material platform assembly module to connect with the frame of the substrate 67 or 3D printer, which is conducive to the disassembly and modular development of the material platform module. The bearing 451 may be a deep groove ball bearing, an angular contact ball bearing and a double-row angular contact ball bearing, the two angular contact ball bearings are arranged in a face-to-face or back-to-back mode, or the two bearings are arranged at intervals in the axial direction. a power input portion of a first driving mechanism is arranged on the fixing ring 39, and the power input portion may be a synchronous pulley 42-1 in FIG. 3, FIG. 4 or FIG. 14 or a gear 474 in FIG. 1, or a rotor or a rotating shaft of the motor; the fixing ring 39 is fixedly connected with the outer ring of the bearing 451, and the platform frame 30 is fixedly connected with the fixing ring 39; the upper portion of the outer ring of the bearing 451 may be fixedly connected with the fixing ring 39, the lower portion of the outer ring is fixed to the platform frame 30, the fixing ring is fixedly connected with the platform frame 30, the inner side of the fixing ring is provided with a first step hole allowing the outer ring to be sleeved and limited on the upper portion of the outer ring, and the inner side of the platform frame 30 is provided with a second step hole allowing the outer ring to be sleeved and limited to the lower portion of the outer ring. When there are two or more bearings, the upper portion of the outer ring of the bearing 451 refers to the upper portion of the outer ring of the upper bearing, and the lower portion of the outer ring of the bearing 451 refers to the lower portion of the outer ring of the lower bearing. For example, the number of the bearings 451 shown in FIG. 14 is two, the two bearings are arranged in an abutting mode, the upper surface and the outer surface of the outer ring of the upper bearing are attached to the fixing ring 39, the lower surface and the outer surface of the outer ring of the bearing below the bearing are attached to the material platform frame, and the outer ring of the fixing ring, the outer ring of the upper bearing 451, the outer ring of the lower bearing 451 and the platform frame may be locked together through screws; or, as shown in FIG. 11, the number of the bearings 451 is two, the two bearings are arranged at intervals, the upper end of the fixing ring 39 abuts against the outer surface and the lower surface of the outer ring of the upper bearing, the lower end of the fixing ring 39 abuts against the outer surface and the upper surface of the outer ring of the lower bearing, the lower surface and the outer surface of the outer ring of the bearing below the fixing ring 39 abut against the material platform frame, and the outer ring of the fixing ring, the outer ring of the lower bearing and the platform frame may be locked together by screws. The upper part of the central shaft 37 may extend outwards to form a step on the top surface of the inner ring of the bearing 451, and the bottom surface of the inner ring may be fixed with the central shaft 37 by a fastener. The central shaft 37 may be provided with an axial via hole for providing a conductive slip ring 36 or for connecting a blast pipe or a cooling pipe, etc.

As shown in FIG. 3, the nozzle seat of the printing head 1 may be driven by the second motor 402 to rotate through a synchronous belt or a gear, for example, the second motor 402 is fixed on the printing seat 11, the outer ring surface of the nozzle seat ring 129 of the nozzle seat 12 may be a synchronous pulley, and the synchronous pulley is meshed (engaged) with the synchronous belt 41-b. Or the nozzle seat may be driven to rotate in a hollow rotor motor. The printing head further comprises a motor, the motor comprises a stator and a rotor (a hollow rotor) with a through hole, the rotor is fixedly connected with the nozzle seat, the stator is arranged outside the rotor in a sleeving mode and fixedly connected with the printing seat, or the rotor is fixedly connected with the printing seat, and the stator is arranged on the inner side of the rotor in a sleeving mode and fixedly connected with the nozzle seat, so that the nozzle seat rotates relative to the printing seat. The rotation of the material platform 3 may be driven by the nozzle seat 12 through at least one of the first printing material filament 2a and the second printing material filament 2b or the first feeding pipe 241 and the second feeding pipe 242 or the second wire portion 852. When the rotation angle of the nozzle seat 12 is small or during the forward and reverse rotation process within a small angle range, due to the small torsion angle of the feeding tube, wire harness, or filament, the material platform 3 may not be driven to rotate. when the rotation angle of the nozzle seat is large, the first feeding tube 241 and the second feeding tube 242, the second part of the wire 852, or the first filament 2a and the second filament 2b, which have twisted enough angles, may drive the material platform 3 to rotate, thereby avoiding excessive increase in the torsion angle of the first feeding tube 241 and the second feeding tube 242, the second part of the wire 852, or the first filament 2a and the second filament 2b, which may affect the function of feeding or wire harness connection. Or the situation that the nozzle seat 12 canot further rotate more angles is avoided. Of course, the platform frame 30 may be independently driven to rotate by the motor, for example, the first motor 401 and the synchronous belt 41-a drive the platform frame 30 to rotate, so that the torsion angles of the first feeding pipe 241 and the second feeding pipe 242, the wire second portion 852 or the first printing material filament 2a and the second printing material filament 2b may be further reduced, and even the zero torsion angles of the feeding pipes 241 and 242, the wire second portion 852 or the first printing material filament 2a and the second printing material filament 2b may be achieved. In FIG. 3, the printing material on the first material spool 321 is a heatable and molten plastic (resin) filamentous printing material 21, and the printing material on the second material spool 322 is a continuous fiber filament material 22, for example, a continuous fiber (such as a continuous carbon fiber) filament material pre-impregnated by a plastic matrix. A cutter 13 is further arranged on the second material-pipe-end 1282 and is used for cutting off the continuous fiber wire material 22 when necessary. It is also illustrated that a sensor 82 using photoelectric sensing or Hall effect is installed on the nozzle seat, and the sensing component 83 (such as a light shielding film or ferromagnetic film) is set on the printing seat 11, the circuit of the sensor 82 may be directly connected to the conductive slip ring 36 through a part of the wiring harness 853 a in the third portion 853 of the lead and then connected to the controller 81. Similarly, the circuit of cutter 13 is also connected to controller 81 through wire harness 853b of wire third part 853, conductive slip ring 36, and wire first part 851. As shown in the diagram, the wiring harness of controller 81 can be divided into at least two parts. The first wiring harness part 851a can be directly connected to components that do not rotate with the material platform 3 or nozzle seat 12, such as a first motor 401 and a dryer 35, or other various electronic devices, such as a motor for driving the print head to move in the XY direction, a motor for printing the platform 6 to move along the Z axis, or a display (these are not shown in the Figure). A controller 81 is connected to the electrically conductive slip ring 36 by a wire first portion 851 to electrically connect to the material platform 3 and electrical devices on the nozzle seat 12.

A plurality of electric devices may also be arranged on the nozzle seat, and the electric devices are connected with the material platform through the flexible line. Referring to FIG. 1, FIG. 2, FIG. 4, FIG. 6 or FIG. 8, devices may be arranged behind and in front of the movement direction of the printing head 1 at the nozzle or the extrusion opening to enhance the printing function, for example, the cooling fan 18, and/or the detector 89, and/or the ink jet head 78 and/or the photosensitive curing light source 75 may be arranged behind; the pre-heater 79, and/or the temperature detector 88 and the like may be arranged in front. By means of the rotation of the nozzle seat or the nozzle seat ring, the electric devices may be kept in the rear or front position of the extrusion opening or the nozzle in the movement direction of the printing head 1, and meanwhile, excessive twisting (excessive winding) of the feeding pipe can be avoided by rotation of the platform frame 30 following the rotation of the nozzle seat or the nozzle seat ring 129, excessive winding between the wires can be avoided, and excessive winding between the feeding pipe and the wire can also be avoided. In addition, when a flexible line is connected between the platform frame and the nozzle seat, not only is a printing material conveying line but also other pipelines or circuits such as a wire (a wire harness), an ink supply pipe, an blast pipe (an air supply pipe) or a cooling pipe, or when the printing material conveying line comprises a plurality of feeding pipes or comprises a plurality of wires, a plurality of ink supply pipes, a plurality of blast pipes or cooling pipes, the platform frame may effectively avoid excessive winding among the flexible lines by following the rotation of the nozzle seat of the printing head. Blast pipes (air supply pipes) or cooling pipes (such as pipes for conveying liquid) may be collectively referred to as fluid pipes. The nozzle seat or nozzle seat ring 129 may have a through-hole 19 through which wires (or wire harnesses) of each of the electric devices described above may be connected upward through the through-hole 19 of the nozzle seat ring 129, and then electrically connected to the nozzle seat by means of a conductive slip ring between the material platform and the base frame or with the nozzle seat, means that the electric devices on the nozzle seat may be connected to the seat frame 126 directly or indirectly with the nozzle seat ring (eg, fixedly connected with the seat frame), the seat frame 126 is fixedly connected with the nozzle seat ring 129, and certainly the nozzle seat ring and the seat frame may also be combined into one part or be regarded as different parts of one part on the nozzle seat.

As shown in FIG. 1, FIG. 2, FIG. 4 and FIG. 6, the cooling fan 18 and the nozzle seat ring 129 are fixedly connected (directly or indirectly) to rotate together, and the cooling fan 18 may adopt an air blower. The optimal cooling fan 18 is arranged behind the moving direction of the printing head 1 and blows air in the direction of the printing material just extruded from the extrusion opening 1201, so that the just-extruded printing material may be rapidly cooled to be solidified and formed. the cooling fan 18 rotates with the nozzle seat ring 129, blowing of other cured model areas is reduced, air blowing cooling is more accurate, the cooling effect is good, the printing speed is improved, excessive cooling of unnecessary areas may be reduced, deformation of the model is reduced, and the printing precision is improved.

As shown in FIG. 1, FIG. 2, FIG. 4 and FIG. 8, an ink jet head 78 may also be arranged on the printing head, the ink jet head 78 and the nozzle seat ring 129 are kept to rotate together, and the ink jet head 78 is directly or indirectly fixedly connected with the nozzle seat ring 129. The lower surface (facing one side surface of the printing bed) of the ink jet head 78 is provided with a plurality of ink jet holes (not shown) which are arranged, for example, the ink jet head in the ink jet printer capable of printing on paper, cloth or film may be adopted. The ink jet head 78 may be kept at the rear position of the movement of the printing head 1 all the time and jet ink towards the printing bed 6. As shown in FIG. 12, according to the movement direction of the printing head 1, if the second extrusion opening 1202 is at the front and the (first) extrusion opening 1201 is at the rear, the ink jet head 78 may be arranged behind the extrusion opening 1201, for example, at the position of the extension line of the connecting line of the second extrusion opening 1202 and the extrusion opening 1201, and optimally, the extension of the connecting line may be a center line of the ink jet head 78 between the left and right. In the printing process, specifically, the surface of the extruded printing material may be sprayed according to the layer pattern information, for example, the color pigment is sprayed, so that the model 60 has a color pattern, or adhesive is sprayed that the bonding strength or sealing performance is improved, or other materials are sprayed. Specifically, as shown in FIG. 12, when the printing head 1 moves along the printing path 9, after the printing material is extruded by the extrusion opening 1201, the ink-jet head 78 may simultaneously jet ink to the surface of the extruded printing material, specifically, the ink-jet head 78 projects towards the area of the printing bed 6 (that is, the surface of FIG. 12) that overlaps with the projection of the newly-extruded printing material 20 in the direction of the printing bed 6, As shown in FIG. 12, the area where the projection of inkjet head 78 and freshly extruded print material 20 overlaps in the direction of printing bed 6 is indicated by the diagonal line filling area. As the print head 1 moves from position A to position B to the right, meanwhile, the nozzle seat ring 129 drives the extrusion opening (such as the extrusion opening 1201 and the second extrusion opening 1202) and the ink jet head 78 to rotate together, for example, the second extrusion opening 1202 and the extrusion opening 1201 are always located on the printing path 9, the width (perpendicular to the movement direction of the printing head) of the ink jet head 78 is overlapped with the projection of the extrusion printing material 20 on the printing bed 6, the controller 81 may dynamically determine the ink jet hole in the overlapping area, the ink jet hole in the overlapping area may perform ink jet according to the ink jet pattern of the printing layer, and a preset pattern is formed on the extruded printing material. Finally, a preset pattern may be formed on the surface or the interior of the model. In addition, the surface of the extruded printing material is subjected to ink-jet forming or coloring while the printing material (melting wire material or continuous fiber filament material) is extruded, so that the printing speed may be improved, the surface of each extruded printing material is flexibly sprayed or colored, the process of forming the pattern on the surface or the interior of the model is more flexible, and the pattern precision is easier to achieve. a ink cartridge 76 is arranged on the material platform 3 (the platform frame 30), ink is contained in the ink cartridge 76, the ink cartridge 76 is communicated with the ink supply pipe 77, the ink supply pipe 7 passes through the nozzle seat ring 129 to be connected to the ink jet head 78, the ink supply pipe 7 is arranged on the nozzle seat 12 (for example, fixedly connected with the nozzle seat ring 129), The flexible line may also include an ink supply tube 77. Of course, multiple ink cartridges can be set, such as four ink cartridges for CMYK four color inks, or ink with different characteristics may be arranged in different ink cartridges, and each ink cartridge is connected to the ink jet head through the corresponding ink supply pipe to be sprayed out through the corresponding spray holes in the ink jet head. During printing, the printing head is located at the rear side position of the printing head in the moving direction, and the printing head may be used for carrying out ink jetting on a printing material just extruded on the printing bed 6 or the printed model 60 on the printing bed 6 to form a pattern or a color pattern or a character or a spraying binder and the like. The weight and volume of the printing head are greatly reduced, the ink jet head 78 may rotate with the nozzle seat 12, the ink jet head 78 may always keep aligned with the orientation of the just-extruded printing material for ink jet, and printing of a model with a surface pattern or a surface color pattern may be realized.

A photosensitive curing light source 75, such as an ultraviolet lamp, may also be arranged in FIG. 8, the photosensitive curing light source 75 is kept to rotate together with the nozzle seat ring 129, and the photosensitive curing light source 75 may be kept at the rear position where the printing head moves all the time and irradiates towards the printing bed 6. When the printing material extruded by the extrusion opening 1201 and/or the second extrusion opening 1202 is a photosensitive material capable of carrying out polymerization reaction on illumination for curing, for example, the first pumping device 521 and/or the second pumping device 522 pump a photosensitive resin material, the photosensitive curing light source 75 irradiates the just-extruded printing material, the just-extruded printing material is subjected to illumination polymerization reaction curing, and the model 60 is cured. photosensitive curing light source 75 may also be used for curing ink sprayed onto the printing material by the ink-jet head 78, for example, the ink-jet head may spray ink capable of being cured by ultraviolet light.

FIG. 1, FIG. 2, FIG. 4, and FIG. 6 illustrate that the print head 1 may also be provided with a detector 89 and kept rotating with the nozzle seat ring 129, the detector 89 being directly or indirectly fixedly connected to the nozzle seat ring 129. The detector 89 may be kept at the rear position of the movement of the printing head 1 all the time and faces the direction of the printing bed 6, and the detector 89 may adopt a camera, a depth camera, a laser radar, a laser scanner or an ultrasonic detector and the like, so that the quality of the extruded printing material may be inspected. As shown in FIG. 12, according to the movement direction of the printing head 1, if the second extrusion opening 1202 is before the extrusion opening 1201, the detector 89 may be arranged behind the extrusion opening 1201 in the moving direction of the printing head, for example, at the position of the extension line of the connection line between the second extrusion opening 1202 and the extrusion opening 1201, and the optimal extension of the connecting line may be a center line of the detector 89 between the left and right. As shown in FIG. 12, when the printing head 1 moves along the printing path 9, after the printing material is extruded by the extrusion opening 1201, the detector 89 performs shooting or laser scanning on the extruded printing material and performs comparative analysis according to the printing path in the layer pattern to judge whether the currently extruded printing material is accurately printed along the printing path or not, whether bubbles or the like exist or not, whether the printing quality can be ensured or not can be judged, and the state information of the just-extruded printing material obtained in real time may be used for adjusting the control of the printing head extrusion process, for example, adjusting the speed of extruding the printing material and the like. The specific surface detection may be that the detection area of the detector 89 projects towards the printing bed 6 (equivalent to the diagram surface of FIG. 12) to be projected to the area overlapped with the just-extruded printing material 20, the detection pattern may be compared with the printing path in the layer pattern, and the coincidence condition, the surface state of the just-extruded printing material 20 and the like may be judged. Meanwhile, the nozzle seat ring 129 drives the extrusion opening (such as the extrusion opening 1201 and the second extrusion opening 1202) and the detector 89 to rotate together, for example, the detection width of the detector 89 (perpendicular to the movement direction of the printing head) is large enough, the detection (laser scanning, ultrasonic detection or camera shooting) area of the detector 89 and the projection of the extrusion printing material 20 on the printing bed 6 are overlapped, so that the state of the printing material 20 may be detected in real time, the printing speed may be improved, and the printing precision and quality may be more easily ensured.

FIG. 1, FIG. 2, FIG. 4, and FIG. 6 may further illustrate that a pre-heater 79 and/or a temperature measurer 88 may also be provided in front of the print head during the movement, and the pre-heater 79 and the temperature measurer 88 both rotate together with the nozzle seat ring 129, for example, fixedly connected to the nozzle seat ring 129, and the temperature measurer 88 and the pre-heater 79 may heat the to-be-printed area of the model 60 (a cured printing material extruded onto the printing bed) to obtain a preset temperature, so as to improve the bonding effect between the extruded printing material (such as a continuous fiber or a molten printing material) and the cured model 60, and improve the bonding strength and the strength of the model. For example, the temperature measurer 88 may be an infrared imager or other instrument capable of temperature measurement, in which the temperature measurer 88 shows an arrow indicating that the direction is detected. For example, the pre-heater 79 may be an infrared heater, a laser, a heating block, a hot air blower, or other instruments that may heat an object, and may be aligned with a second extrusion opening 1202 (or as shown in FIG. 1, FIG. 2, or FIG. 4 aligned with the extrusion opening 1201) to be heated. For example, the preheating block 149 may be arranged in front of the nozzle in FIG. 1, the position of the preheating block 149 is close to the printing bed 6, the heater may heat the preheating block, the temperature sensor may also be arranged to sense the temperature of the preheating block, in the printing process, the preheating block 149 keeps the position in front of the printing head 1 along the movement direction relative to the extrusion opening 1201, the to-be-printed area of the printing material to be extruded out of the extrusion opening 1201 may be baked and heated in advance, and the preheating block 149 may be regarded as an embodiment of the pre-heater 79. In addition, the pre-heater may also adopt an optical fiber, a laser source may be arranged on the material platform 3, the laser source may rotate with the material platform, the laser source is communicated with one end of the optical fiber, the optical fiber passes through a nozzle seat 12 (specifically such as a nozzle seat ring 129) of the printing head 1 downwards, the other end of the optical fiber emits laser for heating to form a pre-heater, and the flexible line may comprise the optical fiber.

In FIG. 3, FIG. 4 and FIG. 6, a printing system for far-end air supply is further illustrated, the fan 7 is arranged on the platform frame 30, air is conveyed to the printing head 1 through the blast pipe (air pipe) 71, for example, blows air towards the printing material just extruded from the extrusion opening, and the just-extruded printing material is rapidly cooled. The air outlet of the fan 7 is communicated with one end of the blast pipe 71. As shown in FIG. 3, the air pipe 71 downwards passes through the opening of the material platform bin 33 and then downwards passes through the through hole 19 of the nozzle seat ring 129 of the nozzle seat to blow air at the position the printing material just extruded at the rear side position of the printing head in moving direction, so that the just extruded printing material is rapidly cooled and shaped, or blows air to the radiator 161 (referring to FIG. 4) on the first material-pipe-end 1281 to keep the proper temperature of the part of the first material-pipe-end 1281 upwards of the first heating block 141 or blow and dissipate heat to the extruder arranged on the nozzle seat. Or blows air to the first radiator and the second radiator in FIG. 2 and FIG. 5 for heat dissipation. The air blowing port 701 of the air pipe (duct) 71 may rotate together with the nozzle seat.

As shown in FIG. 4, FIG. 5 and FIG. 11, an external air source (such as the air source 70 in FIG. 5 and FIG. 11) may also be connected to the printing head through an air supply pipeline through a via hole in the material platform or an axial via hole in the conductive sliding ring 36; the external air source in FIG. 5 is connected to the first part of the blast pipe 70a; the first part of the blast pipe 70a is connected to the sliding sealing ring; and the sliding sealing ring 56 comprises two parts which may rotate and keep sealing, namely the first sliding ring portion 561 and the second sliding ring portion 562, and a sealing ring 563 may also be arranged between the two parts, for example, the first part of the blast pipe 70a is connected to the second sliding ring portion 562, the first sliding ring portion 561 is in communication with the blast pipe 71 (the second part of the blast pipe), the first sliding ring portion 561 may rotate together with the platform frame 30, and the first part of the blast pipe 70a and the second sliding ring portion 562 may be kept not rotating. Of course, the fan 7 may also be arranged on the material platform 3 to send air to the nozzle seat of the printing head 1 through the other blast pipe, for example, the air sent by the air source 70 may be divided into two blast pipes, namely the blast pipe 71 and the third part blast pipe 72 after passing through the sliding sealing ring 56 so as to blow air at multiple positions, for example, the air is sent to the air blowing port 701 and the second air blowing port 702 to blow air to the position of the just-extruded printing material and the radiator 161 on the material-pipe-end, the first valve 731 may be arranged on the first sliding ring portion 561 to adjust the air volume of the blast pipe 71, and the second valve 732 may be further arranged to adjust the air volume of the third part of blast pipe 72. A first part of the blast pipe 70a also passes through the hollow central via hole of the conductive slip ring 36 and then is connected to the second slip ring portion 562 of the sliding seal ring 56, so that the transfer connection effect of the wire harness of the conductive slip ring 36 may be ensured, and the transmission of wind is realized in the central via hole. The external air source 70 may be a compressed air bottle, an air compressor, or a high-pressure fan in a factory. The air blowing port 701 and the second air blowing port 702 may rotate together with the nozzle seat. In this way, far-end air supply may be achieved, a fan and a wire harness (a wire) for a corresponding fan do not need to be arranged on the printing head, the structure and quality of the printing head may be greatly simplified, the moving speed and the positioning precision of the printing head are improved, the stability, speed and precision of the printing process are improved, and the dynamic performance of the printing head is improved. Moreover, the blowing port may be more easily arranged at the target position through the blast pipe for far-end air supply, such as the position of the just-extruded printing material on the rear side of the moving direction of the printing head to accurately supply air, so that the just-extruded printing material is quickly and accurately cooled, air blowing is reduced for the printing model of other areas, accurate and rapid cooling and shaping of the just-extruded printing material may be improved, the printing precision is improved, blowing of unnecessary areas is avoided, the temperature of the whole model is reduced, and the bonding characteristics, deformation and the like of the layer and the layer of the model printing material are affected. The far-end air supply may also perform treatment such as cooling, filtering, drying or pressure regulation on the air, and then the air is sent to the printing head, so that the air blowing cooling effect may be further improved. Similarly, the printing material may also be passed through the central via hole of the conductive slip ring 36 from top to bottom and then transmitted to the extrusion opening on the printing head. The second end of the blast pipe 72 in FIG. 4 and FIG. 11 may blow air to the extruder on the nozzle seat to dissipate heat, so that the situation that the driving force of the extruder on the printing material filament is reduced or blockage is avoided due to the fact that the temperature at the extruder is too high is prevented.

In FIG. 3, FIG. 4, FIG. 6 or FIG. 2, a material bin 33 may be further arranged, for example, the material bin 33 forms a closed space containing material platform 3, so that a printing material on the material platform 3 avoids damp or accumulated dust so as to keep a clean and dry state, and the printing effect is improved. A dryer 35 may also be arranged in the material bin 33 and used for removing moisture in the material bin 33 or detecting the humidity and/or temperature in the material bin, for example, the dryer 35 may be an electric heater, moisture of the printing material is removed through the air temperature in the material bin 33, the temperature of the printing material is properly increased, the printing material may be rapidly heated to a preset temperature, and molten state extrusion printing is rapidly formed. A flexible line such as a feeding pipe, a printing material filament, a wire harness or an blast pipe is sent to the printing head 1 through the opening. The rotating resistance of the material platform 3 or the nozzle seat 12 is reduced. A sliding ring 46 may be arranged at the opening, so that the flexible line passes through the inside of the sliding ring 46, the flexible line is prevented or smaller from friction with the opening of the material bin 33 through the sliding ring 46, for example, the sliding ring 46 may be a ball bearing or a roller bearing which is arranged on the opening, and the inner ring of the sliding ring 46 may freely rotate by the driving of the flexible line such as feeding pipe or the wire harness.

FIG. 4, FIG. 6, FIG. 9 and FIG. 11 show that the second material spool 322 adopts a continuous fiber filament material 22; the corresponding second material tube end 1282 adopts a bent pipe structure and is communicated with the inclined nozzle portion 122; an extrusion opening of the inclined nozzle portion 122 is a second extrusion opening 1202; the axis of a pipeline of the inclined nozzle portion 122 is obliquely arranged with the printing bed 6, and is inclined from top to bottom and towards the extrusion opening 1201, so that the distance between the extrusion opening 1201 and the second extrusion opening 1202 may be greatly reduced. The smaller the vertical distance between the intersection of the extension lines of the axes of the first extrusion opening 1201 and the second extrusion opening 1201 inclined towards the first extrusion opening 1201, the better. The optimal distance is less than the layer thickness of the printing material, or when the second extrusion opening 1202 coincides with the first extrusion port 1201, the distance is 0. During printing, the second extrusion opening 1202 may be kept at the front side of the printing head moving direction all the time, the extrusion opening 1201 is located on the rear side, and the extruded printing material, such as the continuous fiber filament 22, may be more smoothly extruded onto the printing bed 6. Of course, the printing material of the material spool may also be a molten plastic (resin) filament 21. The inclined nozzle portion 122 and bent pipe may be viewed as a portion of the second tube end 1282. It should be noted that the same reference numbers in this article represent components with the same function, and similar components or functions in the accompanying drawings may not be described repeatedly.

In FIG. 4, the first feeding pipe 241 and the second feeding pipe 242 may also pass through the through hole 19 of the nozzle seat ring 129, and may be connected to the first material-pipe-end 1281 and the second material-pipe-end 1282 respectively after passing through, for example, connected to the quick connector above the first material-pipe-end 1281 and the second material-pipe-end 1282 respectively, the extrusion opening, the first material-pipe-end 1281 and the second material-pipe-end 1282 may be fixedly connected to the seat frame 126, the seat frame 126 is fixedly connected with the nozzle seat ring 129, and in addition, the detector 89, the cooling fan 18, the ink jet head 78, the pre-heater 79, the temperature measurer 88 and the like may be fixedly connected to the seat frame 126. A sensor 82 for detecting the turning angle or the rotating zero position of the nozzle seat ring 129 may also be fixedly connected to the seat frame 126, and a passive sensing part 83 may be fixedly connected with the printing seat 11, so that the wire of the sensor 82 may be electrically connected to the controller 81 through the conductive sliding ring 36 on the material platform, so that the wires on the printing head are connected in a unified mode. In addition, the control main board 811 may also be fixedly connected to the seat frame 126. The first feeding pipe 241 and the second feeding pipe 242 pass through the through hole 19 and then are connected to the first material-pipe-end 1281 and the second material-pipe-end 1282, so that the arrangement of the first material-pipe-end 1281 and the second material-pipe-end 1282 is more free, the position of the extrusion opening below may be more flexibly arranged, for example, the axis of the extrusion opening 1201 may coincide with the axis of the nozzle seat ring 129, or the axis of the nozzle seat ring 129 is located at the connecting line midpoint of the extrusion opening 1201 and the second extrusion opening 1202. The arrangement of other electrical components may be more flexible and free. It is also beneficial to reduce the diameter of the through-hole 19. The seat frame 126 in the Figure is only schematic, not necessarily plate-shaped, and may also be a spatial three-dimensional structure. The control main board 811 may also be regarded as a special electric device. Preferably, the seat frame is arranged on the side, away from the material platform, of the relative printing seat, and the near-far comparison is compared in the direction of the flexible line and does not refer to the related linear distance.

A first synchronous pulley 42-1 is fixedly connected to the outer side of the material platform sleeve 302. A second synchronous pulley 42-2 is arranged on an output shaft of the first motor 401 and drives the platform frame 30 to rotate through a synchronous belt 41-a. A bearing 451 is further arranged between the outer edge of the material platform sleeve 302 and the base frame 67. FIG. 7 is a three-dimensional schematic diagram of the printing device. It may be seen from FIG. 7 that the first material spool 321, the first feeder 511, the second spool 322 and the second feeder 512 sequentially surround the rotation axis (such as the axis 910 in FIG. 2) of the material platform 3, the first material spool 321, the first feeder 511, the second material spool 322 and the second feeder 512 are sequentially arranged around the axis 910, and the first material spool 321 and the second material spool 322 are correspondingly arranged relative to the axis 910. Preferably, the axis of rotation of the first spool 321 is parallel or collinear with the axis of rotation of the second spool 322. The whole material platform is compact in structure and small in rotational inertia, the rotary occupied space of the material platform 3 is small, and the vibration of the rotary speed regulation or direction adjustment process is small. The first feeder 511 and the second feeder 512 are correspondingly arranged relative to the axis 910. A first printing wire 2a is wound on the first spool 321. The first printing wire 2a is sent to the first feeder 511 and is conveyed to the printing head through the feeding pipe 241. A second printing wire 2b is wound on the second spool 322. The second printing wire 2b is sent to the second feeder 512 to be transmitted to the printing head 1 through the second feeding pipe 242, so that the discharging port 5111 of the first feeder 511 may be seen to be communicated with the first feeding pipe 241, and the discharging port 5121 of the second feeder 512 is communicated with the second feeding pipe 242.

Of course, parallel printing of more printing materials may also be achieved, as shown in FIG. 7, a third material spool 323 may also be arranged on the material platform, a third printing wire material filament 2c is wound on the third material spool 323, and is sent to the third feeder 513 and sent to the print head 1 through the third feeding tube 243. the first printing wire material filament 2a is sent to the first material-pipe-end 1281 to be extruded through the extrusion opening 1201, and the second printing wire material filament 2b and the third printing wire material filament 2c may be both filamentous continuous fiber materials (For example, continuous fiber filaments pre-impregnated with thermoplastic resin), and are respectively conveyed to a second extrusion opening 1202 and a third extrusion opening 1203 of the second material-pipe-end 1282 for extrusion. The second material pipe end 1282 may also rotate around its own axis, for example, further comprising a driver (such as a server (SERVO)) 47 fixedly connected to the nozzle seat ring 129. A rotating shaft of the driver 47 is connected to the second material pipe end 1282 by means of a first connecting rod 481, a second connecting rod 482, and a third connecting rod 483 which are sequentially pivoted (rotatably connected). When the driver (such as a server) 47 drives the first connecting rod 481 to swing, the second connecting rod 482 drives the third connecting rod 483 to swing, thereby driving the second material pipe portion 1282 to rotate relative to the nozzle seat (or relative to the first material pipe end 1281). When the first material pipe end 1281 and the second material pipe end 1282 rotate relative to the printing seat 11, the second material pipe end 1282 may also rotate relative to the nozzle seat 12 (specifically relative to the nozzle seat ring 129) to form a printing process as shown in FIG. 11. Therefore, two continuous fiber filaments may be extruded at the same time, the fiber content of the continuous fiber printing model is improved, and the printing speed of the model is also improved. The driver (server) is an actuator which adopts an output shaft rotating or limited angle swing formed by combining a microminiature motor and a reduction gear system, may generally accurately control a rotation angle, may determine an actuator of a starting zero point, is generally driven by a PWM model, is commonly used for steering driving in a steering engine driver or a remote control automobile in an unmanned aerial vehicle, is light in weight, small in volume and large in torque, and may also be replaced by a stepping motor and a servo motor. The nozzle seat 12 of the print head 1 in FIG. 3 may include a nozzle seat ring 129 and a first material pipe end 1281 fixedly connected to the nozzle seat ring 129, and the second material pipe portion 1282 is rotatably disposed in or below the nozzle seat ring 129. The outer edge of the nozzle seat ring 129 may be provided with a synchronous pulley, and the synchronous pulley is driven to rotate by a second motor 402 and a synchronous belt 41-b.

As shown in FIG. 7, the nozzle seat of the printing head may also be driven by the dual synchronous pulley mechanism to rotate, the dual synchronous pulley mechanism comprises a first synchronous belt 411, a second synchronous belt 412, a synchronous pulley 42, a first synchronous belt 411, a second synchronous belt 412, a synchronous pulley 42, a first shaft 429-1, a second shaft 429-2, a first guide wheel 426-1, a second guide wheel 426-2, a third guide wheel 426-3 and a fourth guide wheel 426-4, the synchronous pulley 42 is fixedly connected with the nozzle seat, for example, the synchronous pulley 42 and the nozzle seat ring 129 are fixedly connected or integrated into one part, and the first synchronous belt 411 and the second synchronous belt 412 are respectively engaged with opposite sides of the synchronous pulley 42 from top to bottom, the first shaft 429-1 and the second shaft 429-2 are respectively fixed on the printing seat 11 and are respectively fixed on two sides of the synchronous pulley 42 in the tensioning direction along the first synchronous belt 411 or the second synchronous belt 412 (the extending direction of the guide rail 43), the first guide wheel 426-1 and the second guide wheel 426-2 are rotatably arranged on the first shaft 429-1 from top to bottom, the third guide wheel 426-3 and the fourth guide wheel 426-4 are rotatably arranged on the second shaft 429-2 from top to bottom respectively, and the four guide wheels may be smooth wheels with no teeth in the outer contour. The first synchronous belt 411 passes between the first guide wheel 426-1 and the synchronous pulley 42 and passes between the third guide wheel 426-3 and the synchronous pulley 42. The smooth back surface of the first synchronous belt 411 is contact between the first guide wheel 426-1 and he third guide wheel 426-3, and the smooth back surface of the second synchronous belt 412 is respectively in contact with the second guide wheel 426-2 and the fourth guide wheel 426-4. The sliding block 44 is fixed on the printing seat 11 and is in sliding fit with the guide rail 43 to guide the printing head to move in the direction of the guide rail. A back face (eg, one face without teeth) of the first synchronous belt 411 is in contact with the first guide wheel 426-1 and the third guide wheel 426-3, the front face (such as one face of the toothed face) is engaged with one side of the synchronous pulley 42, and the back face (for example, one face without teeth) of the second synchronous belt 412 is in contact with the second guide wheel 426-2 and the fourth guide wheel 426-4, and the front face (such as one face with teeth) is meshed with the other side of the synchronous pulley 42. Therefore, the first synchronous belt 411 and the second synchronous belt 412 may drive the synchronous pulley 42 and the nozzle seat ring 129 to rotate by different moving speeds (different rates or different directions) along the guide rail 43, and may also move along the guide rail. In this way, the nozzle seat ring 129 is driven to rotate, the motor may be prevented from being arranged on the printing head, the quality of the printing head may be greatly reduced, and the printing speed and precision may be improved. Meanwhile, the wire corresponding to the motor may be removed, as shown in FIG. 3, the wire of the second motor 402 does not rotate with the nozzle seat ring 129, the wire may not be combined with the wire passing through the through hole 19, and the complexity of wire arrangement is improved.

Same arranging, the platform frame may also be driven to rotate in the form of a dual synchronous pulley mechanism, that is, the synchronous pulley 42 is fixedly connected with the platform frame and coaxial with the rotating axis of the material platform frame, and the first shaft 429-1 and the second shaft 429-2 are arranged on the base frame. Specifically, the dual synchronous pulley mechanism comprises a first synchronous belt, a second synchronous belt, a synchronous pulley, a first shaft, a second shaft, a first guide wheel, a second guide wheel, a third guide wheel and a fourth guide wheel. The synchronous pulley and the second axis are coaxial and fixedly connected to the platform frame and the third guide wheel and the fourth guide wheel are rotatably arranged on the second shaft from top to bottom, the first synchronous belt passes between the first guide wheel and the synchronous pulley and passes between the third guide wheel and the synchronous pulley, the smooth back face of the first synchronous belt is in contact with the first guide wheel and the third guide wheel respectively, the second synchronous belt passes between the second guide wheel and the synchronous pulley and passes between the fourth guide wheel and the synchronous pulley, and the smooth back face of the second synchronous belt is in contact with the second guide wheel and the fourth guide wheel respectively; and the platform frame is driven to rotate by the moving speed difference of the first synchronous belt and the second synchronous belt. In addition, the pulling of the first synchronous belt and the second synchronous belt in the synchronous pulley mechanism may also drive the printing head or the material platform to move.

In FIG. 4 and FIG. 6, a control mainboard 811 may also be arranged on the nozzle seat, and the control mainboard 811 is electrically connected with the controller 81 by a Bus and through a conductive slip ring. Certainly, the control mainboard 811 may also be arranged on the material platform, or another control mainboard is further arranged on the material platform, the other control mainboard 812 may also be arranged on the material platform 3 in FIG. 4, and the control mainboard is electrically connected with the controller 81 by a Bus. A conductive circuit between the controller 81 (master controller) and the control mainboard includes a Bus. The control mainboard 811 is used for electrically connecting and controlling the electric devices on the nozzle seat or the material platform 3, so that the number of conductive circuits of the conductive sliding ring 36 may be greatly reduced. The following Buses may be adopted, such as CAN, I2C, SPI, Ethernet, UART, GPIO, USB, 232/485 or other Buses. The controller 81 is connected with the control mainboard 811 by a Bus through a conductive slip ring. The electrical device below the nozzle seat ring 129 may be electrically connected with the control mainboard 811 through a wire harness 853. The controller 81 transmits a control instruction to the control mainboard 811 by a Bus. The control mainboard 811 controls each electric device (such as the cutter 13 and the heaters 1431 and 1432 on the heating block), or the control mainboard 811 transmits the data to the controller 81 by the Bus, so that not only is the number of the wires of the conductive slip ring reduced, but also the number of wires penetrating through the through hole 19 of the nozzle seat ring 129 may be reduced, so that the wire arrangement is facilitated, and the diameter size of the nozzle seat ring 129 is reduced. The controller 81 or the control mainboard 811 may be a printed circuit board soldered with a processor chip and a peripheral electronic component, for example, a processor chip adopting an ARM company, an Intel company, an AMD company or an NVIDIA company and the like.

The platform frame 30 is arranged below the base frame 67 or close to one side of the printing head 1, and devices such as a material spool, a feeder (or a wire material extruder) arranged on the platform frame 30, a funnel, a pumping device, a fan, a circulating device or a control panel are also arranged below the base frame 67 or close to the position of one side of the printing head 1. Therefore, when the material platform 3 rotates following the rotation of the nozzle seat 12, a feeding pipe or a wire or other pipelines or the like between the material platform 3 and the nozzle seat 12 may not be interfered by the base frame 67.

FIG. 4, FIG. 6, FIG. 10, and FIG. 11 may also be provided with an roller mechanism. The roller mechanism comprises an roller 611, and an roller 611 for extruding a newly extruded printing material. The roller 611 is rotatably connected to the seat frame 126. The roller 611 may rotate around the axis of the roller 611 and may also rotate or swing around the axis 91. The roller 611 is rotatably arranged at the lower end of the vertical shaft frame 612, the vertical shaft frame 612 may be rotatably connected to the nozzle seat ring 129 around the axis of the vertical shaft frame 612, and the nozzle seat ring 129 may be rotatably arranged on the printing seat 11 around the axis of the nozzle seat ring 129. The nozzle seat ring 129 is provided with a first material-pipe-end 1281 and a second material-pipe-end 1282, the upper ends of the first material-pipe-end 1281 and the second material-pipe-end 1282 are respectively communicated with the first feeding pipe 241 and the second feeding pipe 242, and the lower end of the first material-pipe-end 1281 and the lower end of the second material-pipe-end 1282 are respectively communicated with the extrusion opening 1201 and the second extrusion opening 1202. A printing seat 11 is arranged to move along an arrow 98. The nozzle seat ring 129 rotates along an arrow Φ. The extrusion opening 1201 extrudes a meltable resin material and a second extrusion opening extrudes continuous fiber material. The nozzle seat ring 129 drives the first material-pipe-end 1281 and the second material-pipe-end 1282 to rotate at a preset rotation angle. The rolling extrusion of the roller 611 may increase the combination pre-compaction and strength between the extruded materials, also may extrude bubbles between the materials, increase the mutual combination of the meltable resin material and the continuous fiber material, and may also use the roller 611 to dissipate heat of the just-extruded printing material. The roller 611 is located behind the extrusion opening 1201 relative to the movement direction of the printing head, and drives the roller to rotate around the vertical axis (such as the axis of the vertical shaft frame), for example, the roller may follow the printing path in the printing process, for example, keep the axis of the roller 611 perpendicular to the tangent line of the printing path directly below (directly facing the printing bed 6 direction), or always keep the axis of the roller perpendicular to the normal line of the printing path directly below, or always keep the axis of the roller perpendicular to the moving direction of the roller, and keep pure rolling motion as much as possible.

FIG. 10 illustrates that the first blast pipe (air pipe) 711 can also be passed through the through hole 19 in the nozzle seat ring 129, the upper end of the first blast pipe 711 may be communicated with the air source 70 or the fan 7, the lower end of the first blast pipe 711 may be connected to one end of a rotating shaft of the roller 611, the interior of the roller 611 may be hollow to form an air duct (heat dissipation cavity), the heat dissipation fin may be arranged on the inner wall of the periphery of the roller ring, one end of an air duct in the roller 611 is communicated with the first blast pipe 711, the other end of the air duct is communicated with the second blast pipe 712, and the second blast pipe 712 is connected to the first radiator 16-1 on the first material-pipe-end 1281 and enables the air blowing port of the second blast pipe 712 to face the first radiator 16-1, one end of the heat dissipation channel is communicated with the second blast pipe 712, the other end of the heat dissipation channel may directly discharge heated gas, or the other end of the heat dissipation channel is communicated with the third blast pipe, the third blast pipe may pass through the through hole 19 from bottom to top, the heated gas is discharged above the printing head, and the arrangement is particularly suitable for the situation that the lower portion of the printing head is closed in a closed and heated printing cavity, and gas may be prevented from being poured into the closed cavity. The heat dissipation channel 38 may also be directly formed in a pipe wall processing pipeline of the first material-pipe-end 1281 or the second material-pipe-end 1282, and certainly, the pipeline cannot be communicated with a feeding pipeline in the middle of the first material-pipe-end 1281. The heat dissipation channel 38 may also be a spiral wound pipeline tightly attached to the pipe wall of the first material-pipe-end 1281 or the second material-pipe-end 1282, and the heat dissipation gas may flow in the pipeline for rapid heat dissipation. After the heat dissipation air fed by the second blast pipe 712 passes through the heat dissipation channel 38 of the first material-pipe-end 1281, the heat dissipation air may enter the heat dissipation channel 38 of the second material-pipe-end 1282, and finally the air is dissipated, or is conveyed to the position above the printing head 1 through the through hole 19 through the third blast pipe to be dissipated. Therefore, In this way, when the first blast pipe 711 sends air pass through the through hole 19 to the inside of the extrusion roller 611 for heat dissipation and cooling of the roller 611, and then the air flows to the second blast pipe 712 and finally blows towards the first radiator 161 or the second radiator 162 to dissipate heat, the heat dissipation of the first radiator 161 or the second radiator 162 can be achieved by connecting the roller 611 and the first radiator 161 (and/or the second radiator 162) in series through one air (blast) pipe.

As shown in FIG. 11, the air source or the fan may be replaced by a circulating device of liquid, and the first blast pipe 711, the second blast pipe 712 and the third blast pipe are replaced by the first cooling pipe 94, the second cooling pipe 95 and the third cooling pipe 96 respectively. At this time, the upper end of the first cooling pipe 94 may communicate with the outlet of the circulating device 93 of liquid installed on the platform frame (or communicate with the inlet), the first cooling pipe 94 passes through the through hole 19, the lower end of the first cooling pipe 94 may be connected to one end of the rotating shaft of the roller 611, the interior of the roller 611 may be hollow to form a heat dissipation cavity, and heat dissipation fins may be arranged on the inner wall of the periphery of the roller ring, one end of the heat dissipation cavity in the roller 611 communicates with the first cooling pipe 94, the other end of the heat dissipation cavity communicates with the second cooling pipe 95, the second cooling pipe 95 communicates with an inlet (or a outlet) of the circulating device 93 to circulate a liquid medium, or the second cooling pipe 95 is connected to the heat dissipation channel 38, a first radiator 161 on the first material-pipe-end 1281 and/or a second radiator 162 on the second material-pipe-end 1282 may be arranged in the heat dissipation channel 38, and the other end of the heat dissipation channel 38 communicates with the first cooling pipe 94. As shown in FIG. 11, one end of the heat dissipation channel 38 communicates with the second cooling pipe 95, the other end of the heat dissipation channel 38 communicates with the third cooling pipe 96, the other end of the third cooling pipe 94 communicates with the other end of the heat dissipation cavity of the roller 611 (or the other end of the rotating shaft), the second cooling pipe 95 may pass through the through hole 19 from bottom to top, the heated liquid coolant is discharged to the circulating device 93 for circulation and heat dissipation above the printing head, for example, a heat exchanger (not shown) may be further arranged on the circulating device 93, heat of the heated liquid coolant is dissipated, and then the heated liquid coolant flows back to the inner heat dissipation cavity of the roller 611 through the first cooling pipe 94. The heat dissipation channel 38 may also be directly formed in a pipe wall processing pipeline of the first material-pipe-end 1281 or the second material-pipe-end 1282, and certainly, the pipeline cannot be communicated with a feeding pipeline in the middle of the first material-pipe-end 1281. The heat dissipation channel 38 may also be a spiral wound pipeline tightly attached to the pipe wall of the first material-pipe-end 1281 or the second material-pipe-end 1282, and the heat dissipation fluid may flow in the pipeline for rapid heat dissipation. After liquid coolant passing through the third cooling pipe 96 passes through the heat dissipation channel 38 of the first material-pipe-end 1281, liquid coolant may enter the heat dissipation channel of the second material-pipe-end 1282, finally, liquid coolant is discharged to the circulating device for circulation, or liquid coolant is conveyed through the through hole 19 through the second cooling pipe to be discharged to the circulating device for circulation above the printing head 1. In this way, when the first cooling pipe 94 sends a fluid medium (coolant) to pass through the through hole 19 to the interior of the roller to cool the roller 611, the liquid coolant flows to the third cooling pipe 96 and finally flows through the first radiator 16-1 or the second radiator 16-2 to dissipate heat of the first radiator 16-1 or the second radiator 16-2, so that the heat dissipation at the two positions can be connected in series through one cooling pipe to simultaneously dissipate heat of the roller 611 and the first radiator 16-1 (and/or the second radiator 16-2), and the number of the cooling pipes can be reduced. Of course, the first cooling pipe 94 communicates with one end of the outlet of the circulating device 93 and one end of the heat dissipation cavity of the roller 611, and the second cooling pipe 95 communicates with the inlet of the circulating device 93 and the other end of the heat dissipation cavity of the roller 611; or the first cooling pipe 94 communicates with the outlet of the circulating device 93 and one end of the heat dissipation channel 38, and the second cooling pipe 95 communicates with the inlet of the circulating device 93 and the other end of the heat dissipation channel 38. The heat dissipation cavity in the roller 611 or the heat dissipation channel 38 may also be regarded as a special radiator.

FIG. 10 and FIG. 11 illustrate that the roller 611 is in contact with the freshly extruded printing material, which can facilitate the heat dissipation of the freshly extruded printing material, heat transferred to the roller 611 may be rapidly conducted to the surfaces of the heat dissipation fins on the inner side wall and the inner side wall of the roller 611, so that the heat dissipation effect on the just-extruded printing material may be greatly improved, cooling and solidification of the extruded printing material may be greatly improved, such as, the printing precision or speed is improved, the temperature-rising air or liquid coolant after heat dissipation in the roller 611 conducts heat dissipation on the first radiator 161 or the second radiator 162 through the second blast pipe 712 or the second cooling pipe, or the temperature-rising liquid coolant after heat dissipation in the roller 611 is conveyed back to the circulation device 93 through the second cooling pipe 95.

In general, the driving mode (moving driving mechanism) of the material platform 3 or the printing head 1 may be driven by a rectangular coordinate system (Cartesian kinematics), a cross shaft structure of the ultimaker, an H-shaped driving mechanism of the Makerbot, a synchronous belt driving mechanism, a Core XY mechanism and a delta structure, or a mechanical arm or a robot arm to drive the printing head to move or adopt a gantry frame (such as a gantry milling machine or a truss mechanism of a crane).

The printing material comprises a printing filament and/or a flowable material, the flowable material may be a granular material, a slurry or a liquid material and the like, the printing filament may be a filamentous printing material filament 21 or a fiber printing material filament 22, and the printing filament may be in a filamentous shape, a linear shape or a strip shape. The filamentous printing material filament 21 may be various resin materials such as PLA, ABS, PA, PEEK and the like. For example, a resin filament with a diameter of 1.75 mm or 3 mm is used. The fiber printing material filament 22 may be a continuous fiber printing material (or referred to as a continuous fiber filament material, or a continuous fiber material) may be a fiber material, a metal wire material (such as a copper wire), an optical fiber material, or other continuous linear materials, and may be a continuous fiber material pre-impregnated by a resin. The continuous fiber material may be carbon fibers, glass fibers, polyester, aramid, ceramic fibers, boron fibers, basalt fibers and the like, or metal fibers, SiC fibers, conductive polymer fibers, graphite fibers, boron fibers and silicon nitride fibers. The matrix material for prepreg (infiltration) of continuous fibers may be a thermoplastic or thermosetting plastic material, such as epoxy resin, PLA (polylactic acid), PP (Polypropylene), PE (Polyethylene), ABS (Acrylonitrile Butadiene Styrene), PA (Polyamide, Nylon), PC (Polycarbonate), PS (Polystyrene), PEI (Poly (Etheamide)), PET (Poly (Ethylene Terephthalate)), PEEK (Polyester), TPU (Thermoplastic Polyurethane), and the like, and may also be a photosensitive polymerizable resin material, rubber or other flowable extruded materials, or a metal or low-melting-point alloy, or an acrylate system shape memory polymer and a thiol-olefin system shape memory polymer. The matrix material may also be used as a material of a printing material, a molten material, a meltable wire material or a printing wire material. The particle printing material 23 may be a granular plastic material commonly used in the traditional injection molding industry. Whether the printing material needs to be heated or not is not limited in the extrusion material, and the printing material may be a melt extruded printing material or a printing material which may be cured after flow dynamic extrusion, such as slurry. Of course, it may also be a thermosetting resin material or a photosensitive polymerizable resin material, or other flowable extruded materials. Of course, the printing material may also adopt above various materials.

The feeding pipe, the blast pipe, the cooling pipe, the ink feeding pipe and the like may be made of flexible pipes with elasticity, for example, pipe manufacturing made of polytetrafluoroethylene (Teflon) materials may be adopted. The flexible line between the platform frame of the material platform and the nozzle seat of the printing head may comprise a feeding pipe, the feeding pipe may be communicated with an extrusion unit (a hot end or a material-pipe-end and a nozzle portion) on the nozzle seat through a material spool, a feeder, a pump device, a pumping device or a sliding sealing ring on the material platform frame, and an extrusion opening is formed in the bottom of the extrusion unit; and/or the flexible line further comprises at least one conductive circuit used for being electrically connected, the conductive circuit may be a wire or a wire harness, the wire is connected to the platform frame or the electric device on the nozzle seat through a control mainboard or a sliding electric connecting device (such as a conductive sliding ring), the control mainboard is arranged on the platform frame or on the nozzle seat, the sliding electric connecting device is arranged on the material platform and may be coaxially arranged with the second axis, and the electric device is arranged on the nozzle seat and/or the material platform frame; and/or the flexible line may further comprise a Bus; the Bus is connected to the control main board by a controller arranged on the base frame through a sliding electric connection device; the control main board is arranged on the platform frame or on the nozzle seat; the control main board is connected to the electric device through other wires; and the electric device is arranged on the nozzle seat and/or the material platform frame; and/or the flexible line may further comprise an ink supply pipe used for being connected with an ink cartridge arranged on the material platform and an ink jet head on the nozzle seat; and/or the flexible line may further comprise a cooling pipe or an blast pipe, and the cooling pipe or the blast pipe is communicated with a radiator, a cooler, a heat dissipation channel or an air blowing port on the nozzle seat through a sliding sealing ring, a fan or a circulating device (such as a liquid circulating pump) arranged on the material platform; and the air blowing port may be the end of the blast pipe or may be used for blowing out the air of the blast pipe in the preset direction. The flexible line may further comprise a wire protection sleeve arranged on the outer side of the feeding pipe or the wire in a sleeving mode. When the cooling medium in the cooling pipe is gas, the cooling pipe may adopt an blast pipe, and when the cooling medium in the cooling pipe is liquid, the cooling pipe may be communicated with the circulating device by adopting a circulating pipeline. Alternatively, the blast pipe and the cooling pipe are collectively referred to as a fluid pipe, the circulating device 93 may be collectively referred to as a cooling fluid circulation device, the source of the fan, the air compressor, the gas cylinder or other cooling fluid may be collectively referred to as a fluid source, and the fluid source may be externally connected through the sliding sealing ring.

In the artical, general refers theoretically accurate, but in reality, there are errors in its production or installation, for example, the error is less than +−45 degrees, or the error is less than +−15 degrees. Directional words such as “above”, “below”, “left” and and “right” are described in the text, which is a convenience description based on specific drawings, and is not a limitation on the present invention. In practical application, due to the overall space transformation of the structure, the actual left or right positions may be different from those of the drawings. However, these transformations should be within the protection scope of the present invention.

It should be noted that the above embodiments may be freely combined as required. The above is only the preferred embodiment of the present invention, and it should be pointed out that for a person of ordinary skill in the art, several improvements and modifications may be made without departing from the principle of the present invention, and these improvements and modifications should also be regarded as the protection scope of the present invention.

What is claimed is:

1. A 3D printing system, comprising:
a printing head;
a base frame;
a material platform;
a first driving mechanism; and
a second driving mechanism;
wherein the printing head comprises a printing seat and a nozzle seat; the nozzle seat is arranged on the printing seat; the nozzle seat is configured to rotate around a first axis relative to the printing seat; a side of the nozzle seat along the first axis is provided with an extrusion opening for extruding a printing material;
the material platform comprises a platform frame and at least one feeding component; the platform frame is arranged on the base frame; the platform frame is configured to rotate around a second axis relative to the base frame; the at least one feeding component comprises a rotary follow-up portion arranged on the platform frame; the rotary follow-up portion is configured to rotate with the platform frame;
the first driving mechanism is configured for driving the platform frame to rotate following the rotation of the nozzle seat, and the second driving mechanism is configured for driving the nozzle seat to rotate; and
a flexible line is connected between the platform frame and the nozzle seat, and the flexible line comprises a conveying line; the conveying line is provided between the at least one feeding component and the extrusion opening for conveying the printing material.

2. The 3D printing system according to claim 1, further comprising:
a central shaft; and
a bearing;
wherein the platform frame is configured to rotate relative to the central shaft; the bearing comprises an outer ring and an inner ring which are rotatable relative to each other; the platform frame is fixedly connected with the outer ring; the central shaft is fixedly connected with the inner ring; and the central shaft is fixedly connected with the base frame.

3. The 3D printing system according to claim 2, further comprising:
a fixing ring;
wherein a power input portion of the first driving mechanism is arranged on the fixing ring; and
the fixing ring is fixedly connected with the outer ring, and the platform frame is fixedly connected with the fixing ring; or
an inner side of the fixing ring is provided with a first step hole allowing the outer ring to be sleeved and limited to an upper portion of the outer ring; an inner side of the platform frame is provided with a second step hole allowing the outer ring to be sleeved and limited to a lower portion of the outer ring; the upper portion of the outer ring is fixedly connected with the fixing ring, and the lower portion of the outer ring is fixedly connected with the platform frame; and the fixing ring is fixedly connected with the platform frame.

4. The 3D printing system according to claim 1, further comprising:
a material bin surrounding the material platform;
wherein the material bin is connected to the base frame; along an arrangement direction the flexible line, a side of the material bin close to the printing head is provided with a through hole to allow the flexible line to pass through; a sliding ring is arranged at the through hole, and the flexible line is configured to pass through the sliding ring.

5. The 3D printing system according to claim 1, wherein the nozzle seat comprises a ring with a through hole; the through hole is configured to allow the flexible line to pass through; the nozzle seat further comprises a seat frame, and the seat frame is arranged on a side of the printing seat away from the material platform; the seat frame is connected with the ring, and is configured to rotate with the ring, and the extrusion opening is arranged on the seat frame.

6. The 3D printing system according to claim 1, further comprising:
a controller;
a sliding electric connecting device; and
an electric device;
wherein the electric device is arranged on the nozzle seat and/or the material platform; the sliding electric connecting device comprises a first conductive sliding ring and a second conductive sliding ring which are rotatable relative to each other; and the first conductive sliding ring and the second conductive sliding ring are connected with the base frame and the platform frame, respectively;
the flexible line comprises at least one electrically-conductive line for electrical connection; and
the electric device is electrically connected with the controller through the sliding electric connecting device; or the 3D printing system further comprises a control mainboard, the control mainboard is arranged on the nozzle seat or the material platform, the electric device is electrically connected with the control mainboard, and the control mainboard is electrically connected with the controller through the sliding electric connecting device.

7. The 3D printing system according to claim 6, wherein one of the at least one electrically-conductive line is arranged between the controller and the control mainboard, and comprises a Bus.

8. The 3D printing system according to claim 6, wherein the sliding electric connecting device comprises a via hole;
the 3D printing system further comprises a fluid cooling device, the fluid cooling device comprises a fluid source and a fluid pipeline, a first end of the fluid pipeline is communicated with the fluid source, the fluid pipeline passes through the via hole, and a second end of the fluid pipeline is configured to rotate with the nozzle seat or the platform frame; and
the fluid pipeline is configured to convey a gas coolant or a liquid coolant; and
the flexible line comprises the fluid pipeline.

9. The 3D printing system according to claim 1, wherein the nozzle seat is further provided with at least one electric device, and the flexible line comprises at least one electrically-conductive line for electric connection between the material platform and the nozzle seat; and
the at least one electric device comprises:
a cooling fan, configured to rotate relative to the printing seat through the nozzle seat, located on a rear side of the extrusion opening along a movement direction of the printing head, and configured for blowing towards the printing material extruded from the extrusion opening; and/or
a detector, configured to rotate relative to the printing seat through the nozzle seat, and act on the rear side of the extrusion opening along the movement direction of the printing head to detect a quality of the printing material extruded from the extrusion opening; and/or
a photosensitive-curing light source, configured to rotate relative to the printing seat through the nozzle seat, located on the rear side of the extrusion opening along the movement direction of the printing head, and configured for irradiating and curing the printing material extruded from the extrusion opening; and/or
an ink jet head, configured to rotate relative to the printing seat through the nozzle seat, located on the rear side of the extrusion opening along the movement direction of the printing head, and configured for ejecting an ink on the printing material extruded from the extrusion opening according to a preset pattern; and/or
a pre-heater, configured to rotate relative to the printing seat through the nozzle seat, and configured to emit heat to a front side of the extrusion opening along the movement direction of the printing head to heat an area where is about to be printed by the printing head, or configured for heating the printing material extruded from the extrusion opening; and/or
a temperature measurement instrument, configured to rotate relative to the printing seat through the nozzle seat, and measure a temperature of an area at the front side of the extrusion opening along the movement direction of the printing head.

10. The 3D printing system according to claim 1, wherein a roller is arranged on the nozzle seat; the roller is configured to rotate around its own axis, and rotate around a third axis relative to the nozzle seat through rotation of the nozzle seat relative to the printing seat; the roller is located behind the printing head along a movement direction of the printing head, and is configured for pressing and/or cooling the printing material extruded from the extrusion opening.

11. The 3D printing system according to claim 1, further comprising:
a printing bed; and
an ink cartridge;
wherein the printing bed and the printing head may move relative to each other, the extrusion opening is configured to extrude the printing material along a preset printing path, and the printing bed is configured for printing the printing material;
the nozzle seat is further provided with an ink jet head; the ink jet head is configured to rotate relative to the printing seat through the nozzle seat during a printing process; and the ink jet head is located behind the extrusion opening along a movement in direction of the printing head; a projection of the ink jet head on the printing bed is overlapped with a projection of the printing material extruded from the extrusion opening on the printing bed, and the ink jet head is configured for ejecting an ink on the printing material extruded from the extrusion opening according to a preset pattern; and
the ink cartridge is arranged on the platform frame; the ink cartridge is configured to rotate with the platform frame; the flexible line further comprises an ink supply pipe; and the ink cartridge is communicated with the ink jet head through the ink supply pipe.

12. The 3D printing system according to claim 1, further comprising:
a guide rail;
wherein the printing seat is configured to move along the guide rail;
the nozzle seat comprises a ring with a through hole, and the through hole is configured for the conveying line to pass through;
the nozzle seat further comprises a swing arm; the swing ram is arranged on a side of the printing seat away from the material platform along an arrangement direction of the flexible line; the swing arm is connected with the ring, and is rotatable with the ring; and the extrusion opening is arranged on the swing arm.

13. The 3D printing system according to claim 12, wherein a stroke of the printing seat along the guide rail is greater than or equal to twice a rotation radius of the extrusion opening around the first axis.

14. The 3D printing system according to claim 1, further comprising:
a controller;
wherein the controller is configured to control the second driving mechanism to drive the nozzle seat to rotate, and control the first driving mechanism to drive the platform frame to follow the rotation of the nozzle seat, so that an angle difference between the platform frame and the nozzle seat is smaller than or equal to a preset value; and/or
the platform frame is configured to rotate following the rotation of the nozzle seat in response to a case that a rotation angle of the nozzle seat is greater than or equal to a preset angle value; and/or
a rotation angle range of the platform frame is not greater than a rotation angle range of the nozzle seat; and/or
a rotational angular velocity of the platform frame is not greater than a rotational angular velocity of the nozzle seat; and/or,
a rotational angular acceleration of the platform frame is not greater than a rotational angular acceleration of the nozzle seat.

15. The 3D printing system of claim 1, wherein the base frame is movable; and the 3D printing system further comprises a third driving mechanism;
the third driving mechanism is configured to drive the material platform to follow the movement of the printing head in response to a case that a position difference between the printing head and the material platform is greater than or equal to a preset value; and/or
a movement range of the material platform is not greater than a movement range of the printing head; and/or
a moving speed of the material platform is not greater than a moving speed of the printing head; and/or
a movement acceleration of the material platform is not greater than a movement acceleration of the printing head.

16. The 3D printing system according to claim 1, wherein the second driving mechanism is a dual synchronous belt-pulley mechanism comprising a first synchronous belt, a second synchronous belt, a first synchronous pulley, a first shaft, a second shaft, a first guide wheel, a second guide wheel, a third guide wheel and a fourth guide wheel; the first synchronous pulley is coaxial with the first axis, and is fixedly connected to the nozzle seat; the first synchronous belt and the second synchronous belt are respectively engaged with opposite sides of the first synchronous pulley from top to bottom; the first shaft and the second shaft are fixed on the printing seat, and are respectively arranged at two sides of the first synchronous pulley along a tensioning direction of the first synchronous belt or the second synchronous belt; the first guide wheel and the second guide wheel are rotatably arranged on the first shaft from top to bottom; the third guide wheel and the fourth guide wheel are rotatably arranged on the second shaft from top to bottom; the first synchronous belt is configured to pass between the first guide wheel and the first synchronous pulley, and pass between the third guide wheel and the first synchronous pulley; a smooth back surface of the first synchronous belt is in contact with the first guide wheel and the third guide wheel; the second synchronous belt is configured to pass between the second guide wheel and the first synchronous pulley, and pass between the fourth guide wheel and the first synchronous pulley; a smooth back surface of the second synchronous belt is in contact with the second guide wheel and the fourth guide wheel; and the nozzle seat is configured to be driven to rotate by a moving speed difference between the first synchronous belt and the second synchronous belt; and/or
the first driving mechanism is a dual synchronous belt-pulley mechanism comprising a third synchronous belt, a fourth synchronous belt, a second synchronous pulley, a third shaft, a fourth shaft, a fifth guide wheel, a sixth guide wheel, a seventh guide wheel and an eighth guide wheel; the second synchronous pulley is coaxial with the second axis, and is fixedly connected to the platform frame; the third synchronous belt and the fourth synchronous belt are respectively engaged with opposite sides of the second synchronous pulley from top to bottom; the third shaft and the fourth shaft are fixed on the base frame, and are respectively arranged at two sides of the second synchronous pulley along a tensioning direction of the third synchronous belt or the fourth synchronous belt; the fifth guide wheel and the sixth guide wheel are rotatably arranged on the third shaft from top to bottom; the seventh guide wheel and the eighth guide wheel are rotatably arranged on the fourth shaft from top to bottom; the third synchronous belt is configured to pass between the fifth guide wheel and the second synchronous pulley, and pass between the seventh guide wheel and the second synchronous pulley; a smooth back surface of the third synchronous belt is in contact with the fifth guide wheel and the seventh guide wheel; the fourth synchronous belt is configured to pass between the sixth guide wheel and the second synchronous pulley, and pass between the eighth guide wheel and the second synchronous pulley; a smooth back surface of the fourth synchronous belt is in contact with the sixth guide wheel and the eighth guide wheel; and the platform frame is configured to be driven to rotate by a moving speed difference between the third synchronous belt and the fourth synchronous belt.

17. The 3D printing system according to claim 1, further comprising:
a fluid cooling device;
wherein the fluid cooling device comprises a fluid source and a fluid pipe; an end of the fluid pipe is connected with the fluid source; the fluid source is arranged on the platform frame, and is rotatable with the platform frame;
the fluid source is a fan; the fan is arranged on the platform frame, and is rotatable with the platform frame; the fluid pipe is an air pipe; a first end of the air pipe communicates with the fan; the nozzle seat comprises a ring with a through hole to allow the air pipe to pass through; a second end of the air pipe is rotatable with the nozzle seat, and the flexible line comprises the air pipe; and
the air pipe is rotatable relative to the printing seat through the nozzle seat; the second end of the air pipe is arranged behind the printing head along a movement direction of the printing head, and the second end of the air pipe is configured to blow air towards the printing material extruded from the extrusion opening for heat dissipation; or
the second end of the air pipe is configured to blow air towards a radiator on the nozzle seat, and the radiator is arranged on the conveying line for controlling a temperature of the printing material; or
the nozzle seat further comprises a heat dissipation channel and a material pipe; the second end of the air pipe is communicated with an inlet of the heat dissipation channel; the heat dissipation channel is internally provided with the radiator, or the heat dissipation channel is a pipeline which is formed on a pipe wall of the material pipe and is not communicated with the conveying line, or the heat dissipation channel is a spiral pipeline which is attached to the pipe wall of the material pipe, and the material pipe is a pipeline in the conveying line for conveying the printing material; or
the nozzle seat further comprises a roller; the second end of the air pipe communicates with an inlet of a heat dissipation cavity in the roller, and the roller is connected to the ring, and is rotatable with the ring.

18. The 3D printing system according to claim 1, further comprising:
a fluid cooling device;
wherein the fluid cooling device comprises a fluid source and a fluid pipe; the fluid source is arranged on the platform frame, and is rotatable with the platform frame;
the fluid source is a circulating device, and arranged on the platform frame; the circulating device is configured to rotate together with the platform frame; the fluid pipe is a cooling pipe assembly for conveying a liquid coolant; the cooling pipe assembly comprises a first cooling pipe and a second cooling pipe; a first end of the first cooling pipe communicates with an outlet of the circulating device; a first end of the second cooling pipe communicates with an inlet of the circulating device; the nozzle seat comprises a ring with a through hole; the first cooling pipe and the second cooling pipe pass through the ring; a second end of the first cooling pipe and a second end of the second cooling pipe are rotatable with the nozzle seat; and the flexible line comprises the first cooling pipe and the second cooling pipe; and
the nozzle seat further comprises a heat dissipation channel and a material pipe; the second end of the first cooling pipe communicates with an inlet of the heat dissipation channel, and the second end of the second cooling pipe communicates with an outlet of the heat dissipation channel; the heat dissipation channel is a pipeline which is formed on a pipe wall of the material pipe and is not communicated with the conveying line, or the heat dissipation channel is a spiral pipeline which is attached to the pipe wall of the material pipe; and the material pipe is a pipeline in the conveying line for conveying the printing material; or
the nozzle seat is further provided with a roller; the second end of the first cooling pipe communicates with an inlet of a heat dissipation cavity in the roller, and the second end of the second cooling pipe communicates with an outlet of the heat dissipation cavity in the roller; and the roller is connected to the ring, and is rotatable with the ring; or
the nozzle seat further comprises a roller, a heat dissipation channel and a material pipe; the fluid cooling device further comprises a third cooling pipe; a first end of the third cooling pipe communicates with an outlet of a heat dissipation cavity in the roller, and a second end of the third cooling pipe communicates with an inlet of the heat dissipation channel; the second end of the first cooling pipe communicates with an inlet of the heat dissipation cavity in the roller, and the second end of the second cooling pipe communicates with an outlet of the heat dissipation channel, or the second end of the second cooling pipe communicates with the inlet of the heat dissipation cavity in the roller, and the second end of the first cooling pipe communicates with the outlet of the heat dissipation channel; the heat dissipation channel is a pipeline which is formed on a pipe wall of the material pipe and is not communicated with the conveying line, or the heat dissipation channel is a spiral pipeline which is attached to the pipe wall of the material pipe, and the material pipe is a pipeline in the conveying line for conveying the printing material.

19. The 3D printing system according to claim 1, wherein the nozzle seat is further provided with a screw extruder; a flowable meltable resin printing material or a flowable photosensitive resin printing material is arranged in the screw extruder; the extrusion opening is formed on the screw extruder, and the screw extruder is connected to the nozzle seat, and is rotatable with the nozzle seat;
the at least one feeding component comprises a funnel; the funnel is arranged on the platform frame or connected to the material platform through a sliding sealing ring; the flexible line further comprises a feeding pipe; a first end of the feeding pipe communicates with a discharging port of the funnel, and a second end of the feeding pipe communicates with a feeding port of the screw extruder.

20. The 3D printing system according to claim 1, wherein the extrusion opening comprises a first opening portion and a second opening portion; the material platform is provided with a first spool and a second spool, which are configured as rotary follow-up portions of two feeding components; a first supply pipe is provided between the first opening portion and one of the two feeding components, and a second supply pipe is provided between the second opening portion and the other of the two feeding components; the first material supply pipe and the second material supply pipe are configured as the conveying line; a meltable resin wire material is wound on the first spool; the meltable resin wire material is configured to be conveyed to the first opening portion through the first supply pipe to be extruded; a continuous fiber filament material is wound on the second spool; and the continuous fiber filament material is configured to be conveyed to the second opening portion through the second supply pipe; and
the nozzle seat is configured to rotate relative to the printing seat to keep the second opening portion in front of the first opening portion; and/or
the nozzle seat is configured to rotate relative to the printing seat to keep the second opening portion to incline towards a direction opposite to a movement direction of the printing head; and/or
the second opening portion is integrated into the first opening portion.
